(19) United States
(12) Patent Application Publication
(10) Pub. No.: US 2014/0294312 A1
(43) Pub. Date: Oct. 2, 2014

(54) IMAGE PROCESSING DEVICE AND METHOD

(71) Applicant: Sony Corporation, Minato-ku (JP)

(72) Inventor: Kazushi Sato, Kanagawa (JP)

(73) Assignee: Sony Corporation, Minato-ku (JP)

(21) Appl. No.: 14/344,214

(22) PCT Filed: Oct. 25, 2012
(86) PCT No.: PCT/JP12/77579

§ 371 Date: Mar. 11, 2014

(30) Foreign Application Priority Data
Nov. 2, 2011 (JP) 2011-241720

(51) Int. Cl. G06T 5/00; G06T 9/00

(52) U.S. Cl. CPC G06T 5/001; G06T 9/00
USPC 382/238

(57) ABSTRACT

The present disclosure relates to an image processing device and a method that can reduce degradation of the quality of decoded images.

An image processing device in the present disclosure includes: a determination unit that determines that block distortion is likely to be observed when a predictor used in generating a predicted image of a current image being processed differs from a predictor corresponding to an adjacent image located adjacent to the current image; a control unit that performs control to have a higher strength set in a deblocking filtering process for the current image, when the determination unit determines that block distortion is likely to be observed; and a filtering unit that performs, under the control of the control unit, the deblocking filtering process on the current image. The present disclosure can be applied to image processing devices.

### TECHNICAL FIELD

The present disclosure relates to image processing devices and methods, and relates to an image processing device and a method that reduce degradation of the quality of decoded images.

### BACKGROUND ART

In recent years, to handle image information as digital information and achieve high-efficiency information transmission and accumulation in doing do, apparatuses compliant with a standard, such as MPEG (Moving Picture Experts Group) for compressing image information through orthogonal transforms such as discrete cosine transforms and motion compensation by taking advantage of redundancy inherent to the image information, have spread among broadcast stations to distribute information and among general households to receive information.

Particularly, MPEG2 (ISO (International Organization for Standardization)/IEC (International Electrotechnical Commission) 13818-2) is defined as a general-purpose image encoding standard, and is applicable to interlaced images and non-interlaced images, and to standard-resolution images and high-definition images. Currently, MPEG2 is used in a wide range of applications for professionals and general consumers. According to the MPEG2 compression method, a bit rate of 4 to 8 Mbps is assigned to an interlaced image having a standard resolution of 720×480 pixels, and a bit rate of 18 to 22 Mbps is assigned to an interlaced image having a high-resolution of 1920×1088 pixels, for example. In this manner, high compression rates and excellent image quality can be realized.

MPEG2 is designed mainly for high-quality image encoding suited for broadcasting, but is not compatible with lower bit rates than MPEG1 or encoding methods involving higher compression rates. As mobile terminals are becoming popular, the demand for such encoding methods is expected to increase in the future, and to meet the demand, the MPEG4 encoding method was standardized. As for an image encoding method, the ISO/IEC 14496-2 standard was approved as an international standard in December 1998.

Further, a standard called H.26L (ITU-T (International Telecommunication Union Telecommunication Standardization Sector) Q6/16 VCEG (Video Coding Expert Group)), which is originally intended for encoding images for video conferences, is currently being set. Compared with the conventional encoding techniques such as MPEG2 and MPEG4, H.26L requires a larger amount of calculation in encoding and decoding, but is known to achieve higher encoding efficiency. Also, as a part of the MPEG4 activity, “Joint Model of Enhanced-Compression Video Coding” has been established as a standard for achieving higher encoding efficiency by incorporating functions unsupported by H.26L into the functions based on H.26L.

On the standardization schedule, the standard was approved as an international standard under the name of H.264 and MPEG-4 Part 10 (Advanced Video Coding, hereinafter referred to as AVC) in March 2003.

Further, as an extension of that, FRExt (Fidelity Range Extension) involving encoding tools required for professional use, such as RGB, 4:2:2, and 4:4:4, and 8×8 DCT and quantization matrixes specified in MPEG-2, was set as a standard in February 2005. This is an encoding method for enabling excellent representation of even film noise contained in movie films by using AVC, and is now used in a wide range of applications such as Blu-Ray discs.

However, there is an increasing demand for encoding at a higher compression rate so as to compress UHD (Ultra High Definition; 4000×2000 pixels) images, which has a resolution four times higher than the high-definition image resolution, or distribute high-definition images in today's circumstances where transmission capacities are limited as in the Internet. Therefore, studies on improvement in encoding efficiency is still continued by VCEG (Video Coding Expert Group) under ITU-T.

To achieve higher encoding efficiency than that of AVC, an encoding method called HEVC (High Efficiency Video Coding) is being developed as a standard by JCTVC (Joint Collaboration Team—Video Coding), which is a joint standards organization of ITU-T and ISO/IEC (e.g., see Patent Document 1).

In AVC and HEVC, there is a mode called MV (Motion Vector) competition as an inter prediction mode. In this mode, the bit rate of motion vectors can be reduced by adaptively selecting a spatial predictor (Spatial Predictor), a temporal predictor (Temporal Predictor), or a spatial and temporal predictor (Spatio-Temporal Predictor).

Also, in AVC and HEVC, block distortion is removed from a decoded image by using a deblocking filter at the time of image encoding and decoding.

### CITATION LIST

### Non-Patent Document

NON-PATENT DOCUMENT 1: Benjamin Bross, Woo-Jin Han, Jens-Rainer Ohm, Gary J. Sullivan, Thomas Wiegand, “Working Draft 4 of High-Efficiency Video Coding”, JCTVC-F803_d2, Joint Collaborative Team on Video Coding (JCT-VC) of ITU-T SG16 WP3 and ISO/IEC JTC1/SC29/WG11 6th Meeting: Torino, IT, 14-22 Jul., 2011

### SUMMARY OF THE INVENTION

### Problems to be Solved by the Invention

In the above described MV Competition, a Temporal Predictor is likely to be selected in a still region, and a Spatial Predictor is likely to be selected in a moving object region. Therefore, block distortion is likely to be observed on a boundary between a PU (Prediction Unit) for which a Temporal Predictor is selected and a PU for which a Spatial Predictor is selected.

In a conventional deblocking process, however, such features are not taken into consideration, and block distortion is not thoroughly removed. As a result, there is a possibility that the quality of decoded images will be degraded.

The present disclosure is made in view of those circumstances, and aims to reduce block distortion more accurately and reduce degradation of quality of decoded images by increasing the deblocking filtering strength for a region where block distortion is likely to be observed and a different predictor from that of an adjacent region is selected.

### Solutions to Problems

One aspect of the present disclosure is an image processing device that includes: a determination unit that determines that block distortion is likely to be observed when a predictor used in generating a predicted image of a current image being processed differs from a predictor corresponding to an adjacent image located adjacent to the current image; a control unit that performs control to have a higher strength set in a deblocking filtering process for the current image, when the determination unit determines that block distortion is likely to be observed; and a filtering unit that performs, under the control of the control unit, the deblocking filtering process on the current image.

When the predictor corresponding to the current image is a Spatial Predictor while the predictor corresponding to the adjacent image is a Temporal Predictor, or when the predictor corresponding to the current image is a Temporal Predictor while the predictor corresponding to the adjacent image is a Spatial Predictor, the determination unit may determine that block distortion is likely to be observed.

When bi-prediction is applied to the current image, the determination unit may determine whether block distortion is likely to be observed in the current image, by using a predictor related to the List 0 predictor.

When bi-prediction is applied to the current image, the determination unit may select the List 0 predictor or the List 1 predictor depending on the distance from a reference image, and determine whether block distortion is likely to be observed, by using the selected predictor.

The control unit may control a Bs value of the deblocking filtering process, to have a higher strength set in the deblocking filtering process for the current image determined to be likely to have block distortion to be observed.

The control unit may increase the Bs value by “+1”, to have a higher strength set in the deblocking filtering process for the current image determined to be likely to have block distortion to be observed.

The control unit may adjust the Bs value to “4”, to have a higher strength set in the deblocking filtering process for the current image determined to be likely to have block distortion to be observed.

The control unit may control threshold values α and β of the deblocking filtering process, to have a higher strength set in the deblocking filtering process for the current image determined to be likely to have block distortion to be observed.

The control unit may correct the quantization parameter to be used in calculating the threshold values α and β, to have a higher strength set in the deblocking filtering process for the current image determined to be likely to have block distortion to be observed.

The one aspect of the present disclosure is also an image processing method implemented in an image processing device. The image processing method includes: determining that block distortion is likely to be observed when a predictor used in generating a predicted image of a current image being processed differs from a predictor corresponding to an adjacent image located adjacent to the current image, the determining being performed by a determination unit; performing control to have a higher strength set in a deblocking filtering process for the current image when the determination unit determines that block distortion is likely to be observed, the control being performed by a control unit; and, under the control of the control unit, performing the deblocking filtering process on the current image, the deblocking filtering process being performed by a filtering unit.

In the one aspect of the present disclosure, when the predictor used in generating a predicted image of the current image being processed differs from the predictor corresponding to the adjacent image located adjacent to the current image, the current image is determined to be likely to have block distortion to be observed. When it is determined that block distortion is likely to be observed, control is performed to increase the strength of the deblocking filtering process for the current image, and, under the control, the deblocking filtering process is performed on the current image.

### Effects of the Invention

According to the present disclosure, images can be processed. Particularly, degradation of the quality of decoded images can be reduced.

### BRIEF DESCRIPTION OF DRAWINGS

FIG. 1 is a block diagram showing a typical example structure of an image encoding device.

FIG. 2 is a diagram for explaining the operating principles of the deblocking filter.

FIG. 3 is a diagram for explaining a method of defining Bs.

FIG. 4 is a diagram for explaining the operating principles of the deblocking filter.

FIG. 5 is a diagram showing an example of correspondence relationships between index A and index B, and values of α and β.

FIG. 6 is a diagram showing an example of correspondence relationships among Bs, index A, and tC0.

FIG. 7 is a diagram for explaining example structures of Coding Units.

FIG. 8 is a diagram for explaining an example situation of a median operation.

FIG. 9 is a diagram for explaining an example Multi-Reference Frame.

FIG. 10 is a diagram for explaining an example situation in Temporal Direct Mode.

FIG. 11 is a diagram for explaining an example situation according to a motion vector encoding method.

FIG. 12 is a diagram for explaining an example of Motion Partition Merging.

FIG. 13 is a diagram showing a comparison between predictors.

FIG. 14 is a block diagram showing typical example structures of the motion vector encoding unit, the region determination unit, and the deblocking filter.

FIG. 15 is a diagram for explaining an example of a predictor selection method.

FIG. 16 is a flowchart for explaining an example flow of an encoding process.

FIG. 17 is a flowchart for explaining an example flow of the inter motion prediction process.

FIG. 18 is a flowchart for explaining an example flow of the deblocking filtering process.

FIG. 19 is a block diagram showing a typical example structure of an image decoding device.

FIG. 20 is a block diagram showing typical example structures of the motion vector decoding unit, the region determination unit, and the deblocking filter.

FIG. 21 is a flowchart for explaining an example flow of a decoding process.

FIG. 22 is a flowchart for explaining an example flow of the prediction process.

FIG. 23 is a flowchart for explaining an example flow of the inter prediction process.

FIG. 24 is a block diagram showing a typical example structure of an image encoding device.

FIG. 25 is a block diagram showing typical example structures of the motion vector encoding unit, the region determination unit, and the deblocking filter.

FIG. 26 is a flowchart for explaining an example flow of the deblocking filtering process.

FIG. 27 is a block diagram showing a typical example structure of an image decoding device.

FIG. 28 is a block diagram showing typical example structures of the motion vector decoding unit, the region determination unit, and the deblocking filter.

FIG. 29 is a block diagram showing a typical example structure of a computer.

FIG. 30 is a block diagram showing a typical example structure of a television apparatus.

FIG. 31 is a block diagram showing a typical example structure of a mobile device.

FIG. 32 is a block diagram showing a typical example structure of a recording/reproducing apparatus.

FIG. 33 is a block diagram showing a typical example structure of an imaging apparatus.

### MODES FOR CARRYING OUT THE INVENTION

The following is a description of modes for embodying the present disclosure (hereinafter referred to as the embodiments). Explanation will be made in the following order.

1. First Embodiment (Image Encoding Device and Image Decoding Device)

2. Second Embodiment (Image Encoding Device and Image Decoding Device)

3. Third Embodiment (Computer)

4. Fourth Embodiment (Television Receiver)

5. Fifth Embodiment (Portable Telephone Device)

6. Sixth Embodiment (Recording/Reproducing Apparatus)

7. Seventh Embodiment (Imaging Apparatus)

### 1. FIRST EMBODIMENT

### Image Encoding Device

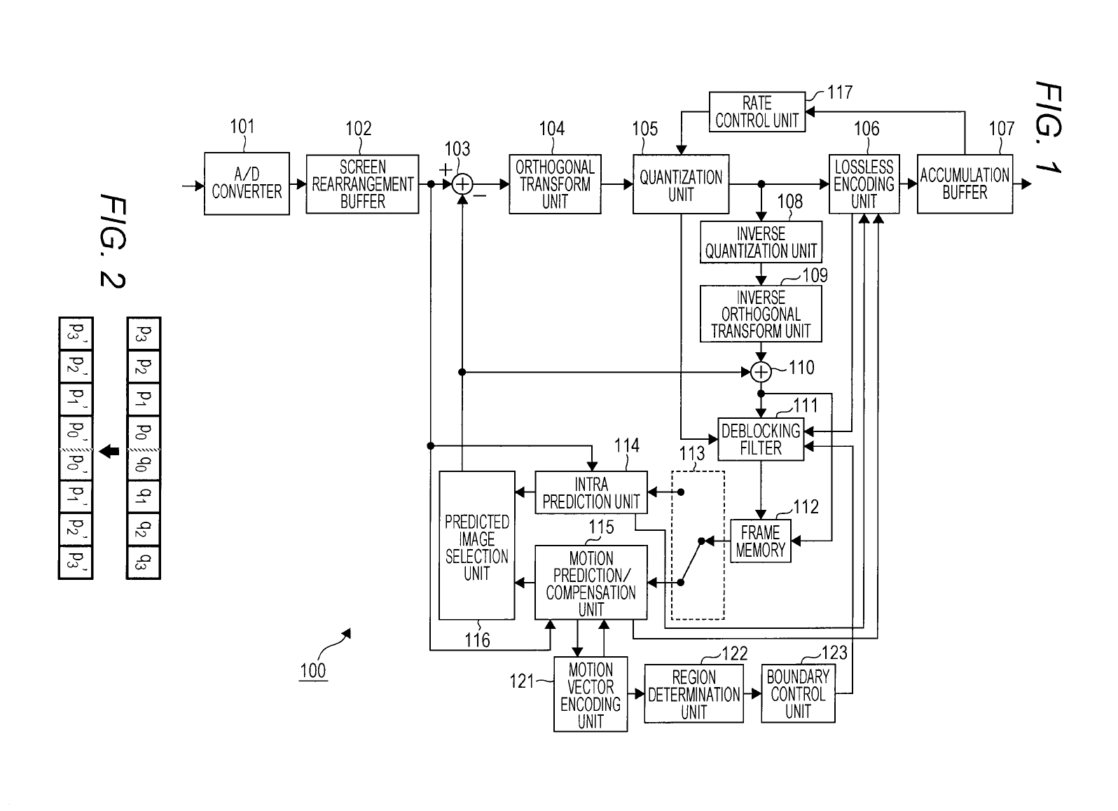

FIG. 1 is a block diagram showing a typical example structure of an image encoding device that is an image processing device to which the present technique is applied.

The image encoding device 100 shown in FIG. 1 encodes image data of moving images by the HEVC (High Efficiency Video Coding) technique or the H.264/MPEG (Moving Picture Experts Group) 4 Part 10 (AVC (Advanced Video Coding)) technique, for example.

As shown in FIG. 1, the image encoding device 100 includes an A/D converter 101, a screen rearrangement buffer 102, an arithmetic operation unit 103, an orthogonal transform unit 104, a quantization unit 105, a lossless encoding unit 106, and an accumulation buffer 107. The image encoding device 100 also includes an inverse quantization unit 108, an inverse orthogonal transform unit 109, an arithmetic operation unit 110, a deblocking filter 111, a frame memory 112, a selection unit 113, an intra prediction unit 114, a motion prediction/compensation unit 115, a predicted image selection unit 116, and a rate control unit 117. The image encoding device 100 further includes a motion vector encoding unit 121, a region determination unit 122, and a boundary control unit 123.

The A/D converter 101 subjects input image data to an A/D conversion, and supplies and stores the converted image data (digital data) into the screen rearrangement buffer 102. The screen rearrangement buffer 102 rearranges the image having frames stored in displaying order in accordance with the GOP (Group of Pictures) structure, so that the frames are arranged in frame order for encoding. The image having the frames rearranged is supplied to the arithmetic operation unit 103. The screen rearrangement buffer 102 supplies each frame image to the arithmetic operation unit 103 for each predetermined partial region that serves as a unit of processing (a unit of encoding) in an encoding process.

The screen rearrangement buffer 102 also supplies the image having the rearranged frame order to the intra prediction unit 114 and the motion prediction/compensation unit 115 for each partial region.

The arithmetic operation unit 103 subtracts a predicted image supplied from the intra prediction unit 114 or the motion prediction/compensation unit 115 via the predicted image selection unit 116, from the image read from the screen rearrangement buffer 102, and outputs the difference information to the orthogonal transform unit 104. When intra encoding is performed on an image, for example, the arithmetic operation unit 103 subtracts a predicted image supplied from the intra prediction unit 114, from the image read from the screen rearrangement buffer 102. When inter encoding is performed on an image, for example, the arithmetic operation unit 103 subtracts a predicted image supplied from the motion prediction/compensation unit 115, from the image read from the screen rearrangement buffer 102.

The orthogonal transform unit 104 performs an orthogonal transform, such as a discrete cosine transform or a Karhunen-Loeve transform, on the difference information supplied from the arithmetic operation unit 103. This orthogonal transform is performed by any appropriate method. The orthogonal transform unit 104 supplies the transform coefficient obtained through the orthogonal transform to the quantization unit 105.

The quantization unit 105 quantizes the transform coefficient supplied from the orthogonal transform unit 104. The quantization unit 105 supplies the quantized transform coefficient to the lossless encoding unit 106.

The lossless encoding unit 106 encodes the transform coefficient quantized by the quantization unit 105 by an appropriate encoding method, and generates encoded data (a bit stream). Since the coefficient data has already been quantized under the control of the rate control unit 117, the bit rate of this encoded data becomes equal to a target value (or approximates a target value) that is set by the rate control unit 117.

The lossless encoding unit 106 acquires intra prediction information indicating an intra prediction mode and the like from the intra prediction unit 114, and acquires inter prediction information indicating an inter prediction mode, motion vector information, and the like from the motion prediction/compensation unit 115.

The lossless encoding unit 106 encodes those various kinds of information by an appropriate encoding method, and incorporates the information into (or multiplexes the information with) the encoded data (bit stream). For example, the lossless encoding unit 106 binarizes and encodes the above described quantization-related parameters (e.g., a difference first quantization parameter and a second quantization parameter) one by one, and stores the quantization-related parameters in the header information or the like of the encoded data of the image data.

The lossless encoding unit 106 supplies and stores the encoded data generated in the above manner, into the accumulation buffer 107. The encoding method used by the lossless encoding unit 106 may be variable-length encoding or arithmetic encoding, for example. The variable-length encoding may be CAVLC (Context-Adaptive Variable Length Coding) specified in H.264/AVC, for example. The arithmetic encoding may be CABAC (Context-Adaptive Binary Arithmetic Coding), for example.

The lossless encoding unit 106 also supplies syntax-element-related information such as intra/inter mode information and motion vector information to the deblocking filter 111.

The accumulation buffer 107 temporarily holds the encoded data supplied from the lossless encoding unit 106. The accumulation buffer 107 outputs the encoded data held therein as a bit stream to a recording device (a recording medium) or a transmission path or the like (not shown) in a later stage, for example, at a predetermined time. That is, the encoded information of various kinds is supplied to the device that decodes encoded data generated through data encoding by the image encoding device 100 (hereinafter the device will be also referred to as the device on the decoding side).

The transform coefficient quantized by the quantization unit 105 is also supplied to the inverse quantization unit 108. The inverse quantization unit 108 inversely quantizes the quantized transform coefficient by a method compatible with the quantization performed by the quantization unit 105. The inverse quantization unit 108 supplies the obtained transform coefficient to the inverse orthogonal transform unit 109.

The inverse orthogonal transform unit 109 performs an inverse orthogonal transform on the transform coefficient supplied from the inverse quantization unit 108 by a method compatible with the orthogonal transform performed by the orthogonal transform unit 104. The output subjected to the inverse orthogonal transform (the locally restored difference information) is supplied to the arithmetic operation unit 110.

The arithmetic operation unit 110 obtains a locally reconstructed image (hereinafter referred to as the reconstructed image) by adding a predicted image supplied from the intra prediction unit 114 or the motion prediction/compensation unit 115 via the predicted image selection unit 116 to the inverse orthogonal transform result or the locally restored difference information supplied from the inverse orthogonal transform unit 109. The reconstructed image is supplied to the deblocking filter 111 or the frame memory 112.

The deblocking filter 111 performs, as appropriate, a deblocking filtering process on the reconstructed image supplied from the arithmetic operation unit 110, to remove block distortion from the reconstructed image. Also, to improve image quality, a loop filtering process using a Wiener filter may be performed on the result of the deblocking filtering process (the reconstructed image from which block distortion has been removed). The deblocking filter 111 may further perform other appropriate filtering processes on the reconstructed image. The deblocking filter 111 supplies the result of the filtering process (hereinafter referred to as the decoded image) to the frame memory 112.

The frame memory 112 stores both the reconstructed image supplied from the arithmetic operation unit 110 and the decoded image supplied from the deblocking filter 111. At a predetermined time or in accordance with a request from outside such as from the intra prediction unit 114, the frame memory 112 supplies the stored reconstructed image to the intra prediction unit 114 via the selection unit 113. At a predetermined time or in accordance with a request from outside such as from the motion prediction/compensation unit 115, the frame memory 112 also supplies the stored decoded image to the motion prediction/compensation unit 115 via the selection unit 113.

The selection unit 113 indicates the destination to which an image output from the frame memory 112 is to be supplied. In the case of an intra prediction, for example, the selection unit 113 reads the image not subjected to a filtering process (the reconstructed image) from the frame memory 112, and supplies the image as an adjacent pixel to the intra prediction unit 114.

In the case of an inter prediction, for example, the selection unit 113 reads the image subjected to a filtering process (the decoded image) from the frame memory 112, and supplies the image as a reference image to the motion prediction/compensation unit 115.

Acquiring an image (an adjacent image) of an adjacent region located adjacent to the current region from the frame memory 112, the intra prediction unit 114 performs intra predictions (intra-screen predictions) to generate predicted images by using the pixel value of the adjacent image, with the unit of processing being basically a Prediction Unit (PU). The intra prediction unit 114 performs the intra predictions in more than one mode (intra prediction modes) that is prepared in advance.

The intra prediction unit 114 generates predicted images in all the candidate intra prediction modes, evaluates the cost function values of the respective predicted images by using the input image supplied from the screen rearrangement buffer 102, and selects an optimum mode. After selecting the optimum intra prediction mode, the intra prediction unit 114 supplies the predicted image generated in the optimum intra prediction mode to the predicted image selection unit 116.

The intra prediction unit 114 also supplies the intra prediction information including intra-prediction-related information such as the optimum intra prediction mode to the lossless encoding unit 106, which then encodes the intra prediction information.

Using the input image supplied from the screen rearrangement buffer 102, and the reference image supplied from the frame memory 112, the motion prediction/compensation unit 115 performs motion predictions (inter predictions), and performs a motion compensation process in accordance with the detected motion vectors, to generate a predicted image (inter-predicted image information). In the motion predictions, a PU (inter PU) is used basically as a unit of processing. The motion prediction/compensation unit 115 performs such inter predictions in more than one mode (inter prediction mode) that is prepared in advance.

Specifically, the motion prediction/compensation unit 115 generates predicted images in all the candidate inter prediction modes, evaluates the cost function values of the respective predicted images, and selects an optimum mode. At this point, the motion prediction/compensation unit 115 causes the motion vector encoding unit 121 to determine an optimum motion vector predictor, where appropriate. The motion prediction/compensation unit 115 regards the mode using the optimum predictor as an option.

After selecting the optimum inter prediction mode, the motion prediction/compensation unit 115 supplies the predicted image generated in the optimum intra prediction mode to the predicted image selection unit 116. The motion prediction/compensation unit 115 also supplies the inter prediction information including inter-prediction-related information such as the optimum inter prediction mode to the lossless encoding unit 106, which then encodes the inter prediction information.

The predicted image selection unit 116 selects the supplier of a predicted image to be supplied to the arithmetic operation unit 103 and the arithmetic operation unit 110. In the case of intra encoding, for example, the predicted image selection unit 116 selects the intra prediction unit 114 as the supplier of a predicted image, and supplies the predicted image supplied from the intra prediction unit 114 to the arithmetic operation unit 103 and the arithmetic operation unit 110. In the case of inter encoding, for example, the predicted image selection unit 116 selects the motion prediction/compensation unit 115 as the supplier of a predicted image, and supplies the predicted image supplied from the motion prediction/compensation unit 115 to the arithmetic operation unit 103 and the arithmetic operation unit 110.

Based on the bit rate of the encoded data accumulated in the accumulation buffer 107, the rate control unit 117 controls the quantization operation rate of the quantization unit 105 so as not to cause an overflow or underflow.

Acquiring a motion prediction result (motion vector information) from the motion prediction/compensation unit 115, the motion vector encoding unit 121 selects the predictor optimum for generating a predicted value of the motion vector (the optimum predictor) through the MV competition, the Merge Mode, or the like. The motion vector encoding unit 121 then supplies information about the optimum predictor and the like to the motion prediction/compensation unit 115 and the region determination unit 122.

The region determination unit 122 determines whether the optimum predictor of the current region selected by the motion vector encoding unit 121 differs from the optimum predictor of the adjacent region, and supplies a result of the determination to the boundary control unit 123.

The boundary control unit 123 controls the settings of the deblocking filter 111 in accordance with the result of the determination performed by the region determination unit 122. Under the control of the boundary control unit 123, the deblocking filter 111 adjusts its filtering strength, and performs a deblocking filtering process.

[Deblocking Filter]

In AVC and HEVC, a deblocking filter is included in the loop, as in the image encoding device 100. With this arrangement, block distortion can be effectively removed from decoded images, and motion compensation can effectively prevent block distortion from propagating to images referring to the decoded image.

In the following, the operating principles in each deblocking filter according to the AVC encoding method are described.

As operations of a deblocking filter of AVC, the following three operations can be designated in accordance with the two parameters, deblocking_filter_control_present_flag in a picture parameter set and disable_deblocking_filter_idc in a slice header, which are contained in compressed image information.

(a) To be performed on a block boundary or a macroblock boundary

(b) To be performed only on a macroblock boundary

(c) Not to be performed

As for a quantization parameter QP, QPY is used when the following process is performed on luminance signals, and QPC is used when the following process is performed on chrominance signals. In motion vector encoding, intra predictions, and entropy encoding (CAVLC/CABAC), pixel values that belong to different slices are processed as “unavailable”. However, in deblocking filtering processes, pixel values that belong to different slices but belong to the same picture are processed as “available”.

In the following, pixel values yet to be subjected to a deblocking filtering process are represented by p₀ through p₃ and q₀ through q₃, and processed pixel values are represented by p′₀ through p′₃ and q′₀ through q′₃, as shown in FIG. 2.

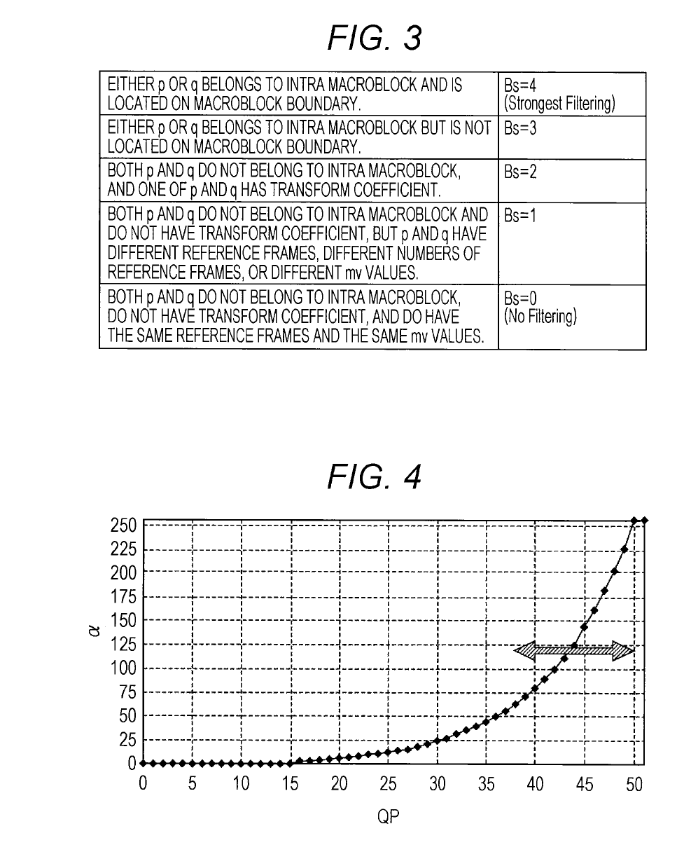

As shown in FIG. 3, prior to a deblocking filtering process, Bs (Boundary Strengths) are defined on the ps and qs shown in FIG. 2.

Only when the following two conditions (the expressions (1) and (2)) are satisfied, is a deblocking filtering process performed on (p₂, p₁, p₀, q₀, q₁, and q₂) in FIG. 3.

Bs>0 (1)

|p₀−q₀|<α; |p₁−p₀|<β; |q₁−q₀|<β (2)

Although the default values of α and β in the expression (2) are defined in accordance with QP as shown below, the values can be adjusted by a user in accordance with the two parameters “slice_alpha_c0_offset_div2” and “slice_beta_offset_div2” contained in the slice header in compressed image information (or in encoded data), as shown in FIG. 4.

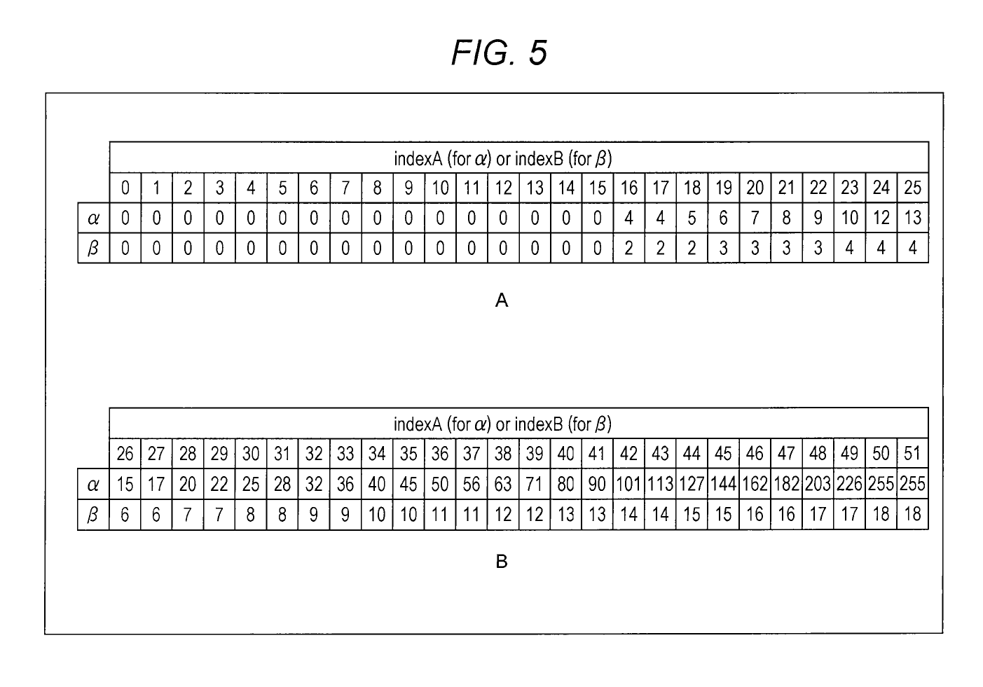

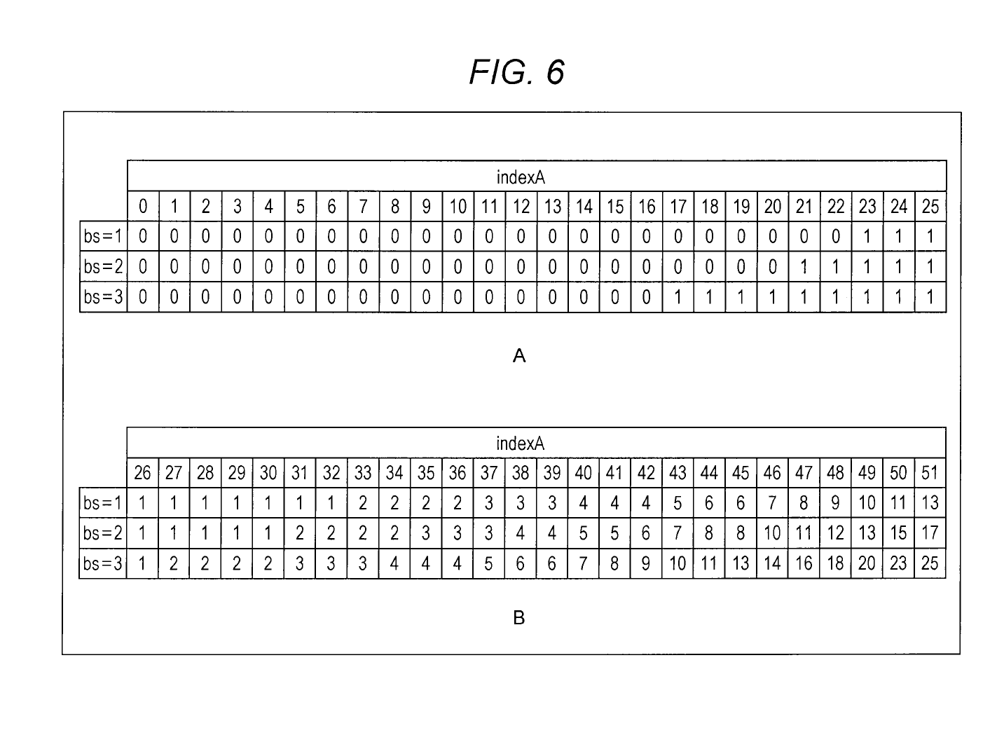

In FIG. 5, the “index A” and “index B” are defined as shown in the following expressions (3) through (5).

[Mathematical Formula 1]

qPₐᵥ=(qPₚ+qP_{q}+1)>>1 (3)

[Mathematical Formula 2]

indexA=Clip3(0,51,qPₐᵥ+FilterOffsetA) (4)

[Mathematical Formula 3]

indexB=Clip3(0,51,qPₐᵥ+FilterOffsetB) (5)

In the above expressions (3) through (5), “FilterOffsetA” and “FilterOffsetB” are equivalent to the portions to be adjusted by the user.

Different methods are defined for deblocking filtering processes in cases (1) where Bs<4, and (2) where Bs=4, as described below.

Where Bs<4, the pixel values p′₀ and q′₀ subjected to a deblocking filtering process are calculated according to the following expressions (6) through (8).

[Mathematical Formula 4]

Δ=Clip3(−t_{c},tc((((q₀−p₀)<<2)+(p₁−q₁)+4)>>3)) (6)

[Mathematical Formula 5]

P′₀=Clip1(p₀+Δ) (7)

[Mathematical Formula 6]

q′₀=Clip1(q₀+Δ) (8)

Here, t_{c} is calculated as described below. Specifically, where the value of chromaEdgeFlag is 0, t_{c} is calculated according to the expression (9) shown below. In other cases, t₀ is calculated according to the expression (10) shown below.

[Mathematical Formula 7]

t_{c}=t_{c0}+((aₚ<β)?1:0)+(a_{q}<β)?1:0) (9)

[Mathematical Formula 8]

t_{c}=t_{c0}+1 (10)

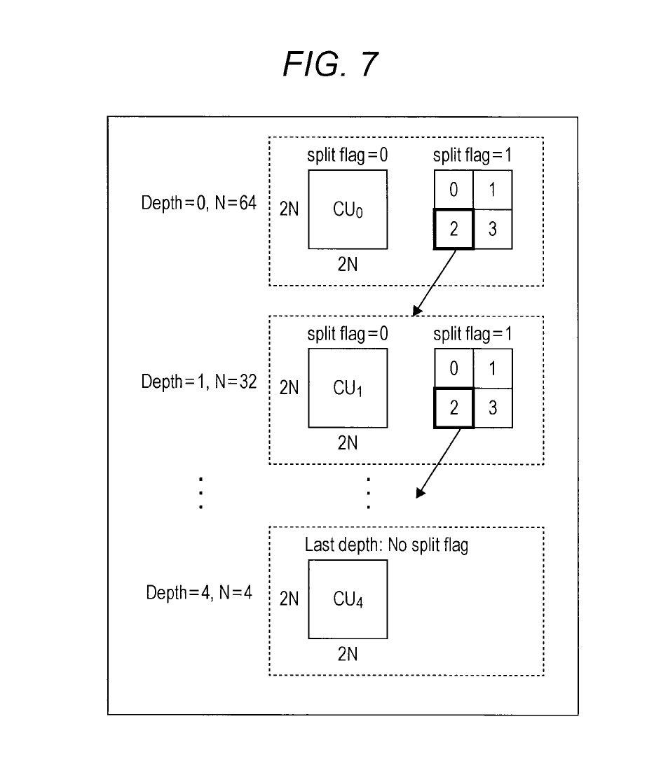

The value of t_{c0} is defined in accordance with the values of Bs and “index A”, as shown in the tables in FIG. 7. Meanwhile, the values of aₚ and a_{q} are calculated according to the following expressions (11) and (12).

[Mathematical Formula 9]

aₚ=|p₂−p₀| (11)

[Mathematical Formula 10]

a_{q}=|q₂−q₀| (12)

The pixel value p′₁ subjected to the deblocking filtering process is calculated as described below. That is, when the value of chromaEdgeFlag is 0, and the value of aₚ is equal to or smaller than β, p′₁ is calculated according to the expression (13) shown below. When this condition is not satisfied, p′₁ is calculated according to the expression (14) shown below.

[Mathematical Formula 11]

p′₁=p₁+Clip3(−t_{c0},t_{c0},(p₂+((p₀+q₀+1)−1)>>1)−(p₁<<1))>>1) (13)

[Mathematical Formula 12]

p′₁=p₁ (14)

The pixel value q′₁ subjected to the deblocking filtering process is calculated as described below. That is, when the value of chromaEdgeFlag is 0, and the value of a_{q} is equal to or smaller than β, q′₁ is calculated according to the expression (15) shown below. When this condition is not satisfied, q′₁ is calculated according to the expression (16) shown below.

[Mathematical Formula 13]

q′₁=q₁+Clip3(−t_{C0},t_{c0},(q₂+((p₀+q₀+1)>>1)−(q₁<<1))>>1) (15)

[Mathematical Formula 14]

q′1=q₁ (16)

The values of p′₂ and q′₂ are the same as the values of p₂ and q₂, which have not been filtered yet. That is, p′₂ and q′₂ are calculated according to the following expressions (17) and (18).

[Mathematical Formula 15]

p′₂=p₂ (17)

[Mathematical Formula 16]

q′₂=q₂ (18)

Where Bs=4, the pixel values p′ᵢ (i=0, . . . , 2) subjected to the deblocking filtering process are calculated as described below. That is, when the value of chromaEdgeFlag is 0, and the condition shown below (the expression (19)) is satisfied, p′₀, p′₁, and p′₂ are calculated according to the expressions (20) through (22) shown below. When the above mentioned condition is not satisfied, p′₀, p′₁, and p′₂ are calculated according to the expressions (23) through (25) shown below.

[Mathematical Formula 17]

aₚ<β&&|p₀−q₀|<((α>>2)+2) (19)

[Mathematical Formula 18]

p′₀=(p₂+2·p₁+2p₀+2·q₀+q₁+4)>>3 (20)

[Mathematical Formula 19]

p′₁=(p₂+p₁+p₀+q₀+2)>>2 (21)

[Mathematical Formula 20]

p′₂=(2·p₃α3·p₂+p₁+p₀+q₀+4)>>3 (22)

[Mathematical Formula 21]

p′₀=(2·p₁+p₀+q₁+2)>>2 (23)

[Mathematical Formula 22]

p′₁=p₁ (24)

[Mathematical Formula 23]

p′₂=p₂ (25)

The pixel values q′ᵢ (i=0, . . . , 2) subjected to the deblocking filtering process are calculated as described below. That is, when the value of chromaEdgeFlag is 0, and the condition shown below (the expression (26)) is satisfied, q′₀, q′₁, and q′₂ are calculated according to the expressions (27) through (29) shown below. When the above mentioned condition is not satisfied, q′₀, q′₁, and q′₂ are calculated according to the expressions (30) through (32) shown below.

[Mathematical Formula 24]

a_{q}<β&&|p₀−q₀|<((α>>2)+2) (26)

[Mathematical Formula 25]

q′₀=(p₁+2·p₀+2·q₀+2·q₁+q₂+4)>>3 (27)

[Mathematical Formula 26]

q′₁=(p₀+q₀+q₁+q₂+2)>>2 (28)

[Mathematical Formula 27]

q′₂=(2·q₃+3·q₂+q₁+q₀+p₄+4)>>3 (29)

[Mathematical Formula 28]

q′₀==(2·q₁+q₀+p₁+2)>>2 (30)

[Mathematical Formula 29]

q′₁=q₁ (31)

[Mathematical Formula 30]

q′₂=q₂ (32)

[Coding Units]

Coding Units (CUs) specified by the HEVC encoding technique are now described.

Coding Units (CUs) are also called Coding Tree Blocks (CTBs), and are partial regions of a multi-layered structure of picture-based images that have the same roles as those of macroblocks in AVC. That is, CUs are units for encoding processes (units of encoding). While the size of a macroblock is limited to 16×16 pixels, the size of a CU is not limited to a certain size, and may be designated by compressed image information in each sequence.

Particularly, a CU having the largest size is called a Largest Coding Unit (LCU), and a CU having the smallest size is called a Smallest Coding Unit (SCU). That is, LCUs are the largest units of encoding, and SCUs are the smallest units of encoding. In a sequence parameter set included in compressed image information, for example, the sizes of those regions are designated, but the regions are restricted to squares represented by a power of 2. That is, the respective regions formed by dividing a (square) CU at a certain hierarchical level by 2×2=4 are (square) CUs one hierarchical level lower.

FIG. 7 shows examples of Coding Units defined in HEVC. In the example shown in FIG. 2, the size of each LCU is 128 (2N (N=64), and the greatest hierarchical depth is 5 (Depth=4). When the value of split flag is “1”, a CU of 2N×2N in size is divided into CUs of N×N in size, which are one hierarchical level lower.

Each of the CUs is further divided into Prediction Units (PUs) that are processing-unit regions (partial regions of picture-based images) for intra or inter predictions, or are divided into Transform Units (TUs) that are processing-unit regions (partial regions of picture-based images) for orthogonal transforms.

As for inter prediction units (PUs), the four sizes, 2N×2N, 2N×N, N×2N, and N×N, can be set in a CU of 2N×2N in size. Specifically, in a CU, it is possible to define a PU of the same size as the CU, two PUs formed by vertically or horizontally dividing the CU by two, or four PUs formed by vertically and horizontally dividing the CU by two.

The image encoding device 100 performs encoding-related processes, with such partial regions in picture-based images being units of processing. In the following, a case where the image encoding device 100 uses the CUs defined in HEVC as units of encoding is described. That is, LCUs are the largest units of encoding, and SCUs are the smallest units of encoding. However, the units of processing in the respective encoding processes to be performed by the image encoding device 100 are not limited to those, and may be arbitrarily set. For example, the macroblocks and sub-macroblocks defined in AVC may be used as units of processing.

In the following description, “(partial) regions” include all (or some of) the above described regions (such as macroblocks, sub-macroblocks, LCUs, CUs, SCUs, PUs, and TUs). The (partial) regions may of course include units other than the above described ones, and unsuitable units will be excluded depending on context.

[Motion Vector Median Predictions]

In AVC or HEVC, however, there is a possibility that an enormous amount of motion vector information will be generated if motion prediction/compensation processes are performed as in the case of MPEG2. Encoding the generated motion vector information without any change might lead to a decrease in encoding efficiency.

To solve this problem, the method described below is used in AVC image encoding, and a decrease in the amount of encoded motion vector information is realized.

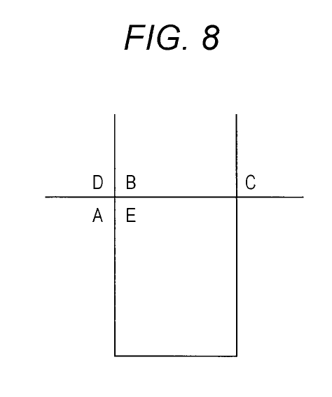

Each straight line shown in FIG. 8 indicates a boundary between motion compensation blocks. In FIG. 8, E represents the current motion compensation block to be encoded, and A through D each represent a motion compensation block that has already been encoded and is adjacent to E.

Where X is A, B, C, D, or E, mvₓ represents the motion vector information about a block X.

By using the motion vector information about the motion compensation blocks A, B, and C, predicted motion vector information pmv_{E} about the motion compensation block E is generated through a median operation as shown in the following equation (33).

[Mathematical Formula 31]

pmv_{E}=med(mv_{A},mv_{B},mv_{c}) (33)

If the information about the motion compensation block C is “unavailable” because the block C is located at a corner of the image frame or the like, the information about the motion compensation block D is used instead.

In the compressed image information, the data mvd_{E} to be encoded as the motion vector information about the motion compensation block E is generated by using pmv_{E} as shown in the following equation (34).

[Mathematical Formula 32]

mvd_{E}=mv_{E}−pmv_{E} (34)

In an actual process, processing is performed on the horizontal component and the vertical component of the motion vector information independently of each other.

[Multi-Reference Frames]

In AVC, the Multi-Reference Frame method, which is not specified by conventional image encoding techniques such as MPEG2 and H.263, is specified.

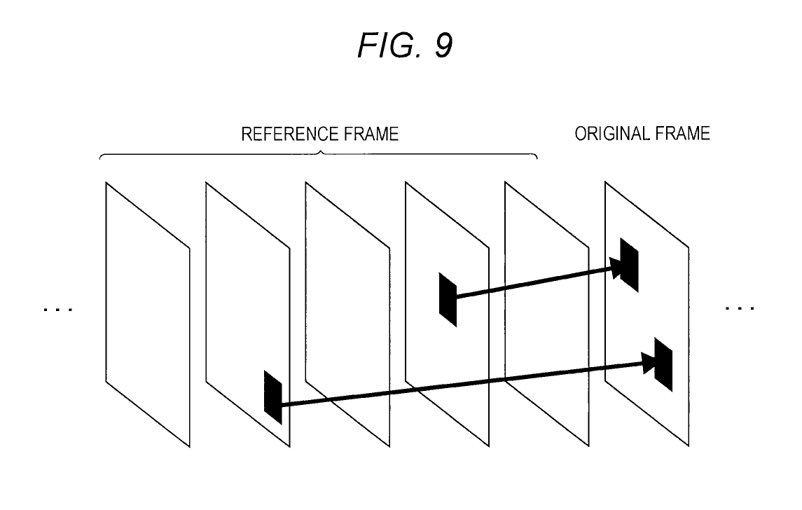

Referring now to FIG. 9, Multi-Reference Frames specified in AVC are described.

In MPEG-2 and H.263, a motion prediction/compensation process is performed by referring to only one reference frame stored in a frame memory in the case of a P-picture. In AVC, however, more than one reference frame is stored in a memory, and a different memory can be referred to for each macroblock, as shown in FIG. 9.

[Direct Modes]

Although the amount of motion vector information in a B-picture is very large, there are predetermined modes called Direct Modes in AVC.

In Direct Modes, motion vector information is not stored in compressed image information. In an image decoding device, the motion vector information about the current block is calculated from the motion vector information about an adjacent block or the motion vector information about a co-located block that is a block located in the same position as the current block in a reference frame.

Direct Modes include the two modes: Spatial Direct Mode and Temporal Direct Mode. One of the two modes can be selected for each slice.

In Spatial Direct Mode, the motion vector information mvE about the current motion compensation block E is calculated as shown in the following equation (35).

mv_{E}=pmv_{E} (35)

That is, motion vector information that is generated through a median prediction is applied to the current block.

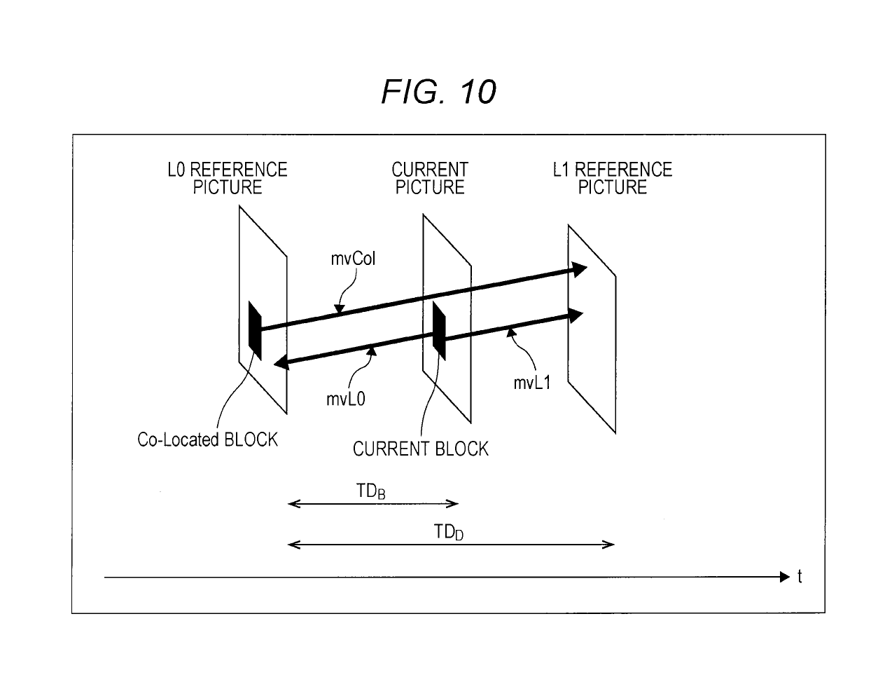

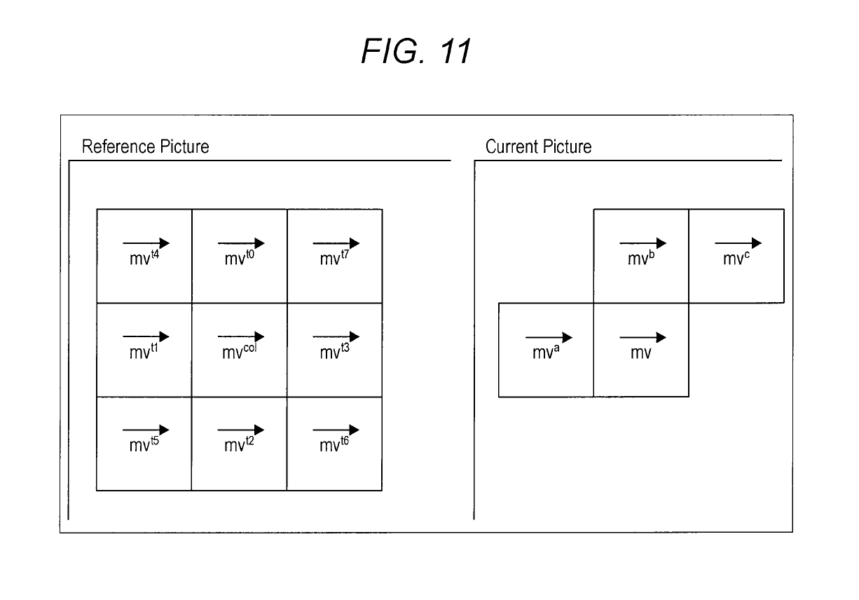

Referring now to FIG. 10, Temporal Direct Mode is described.

In FIG. 10, a block located at the address in the same space as the current block in a L0 reference picture is referred to as a co-located block, and the motion vector information about the co-located block is represented by mv_{col}. Also, TD_{B} represents the distance on the temporal axis between the current picture and the L0 reference picture, and TD_{D} represents the distance on the temporal axis between the L0 reference picture and an L1 reference picture.

At this point, the motion vector information mv_{L0} about L0 and the motion vector information mv_{L1} about L1 in the current picture are calculated as shown in the following equations (36) and (37).

$$\begin{matrix} [ Mathematical Formula 33 ] & \\ {mv}_{L 0} = \frac{{TD}_{B}}{{TD}_{D}} {mv}_{col} & ( 36 ) \\ [ Mathematical Formula 34 ] & \\ {mv}_{L 1} = \frac{{TD}_{D} - {TD}_{B}}{{TD}_{D}} {mv}_{col} & ( 37 )\end{matrix}$$

In AVC compressed image information, information TD indicating a distance on the temporal axis does not exist, and therefore, the calculations according to the above mentioned equations (36) and (37) are performed by using POC (Picture Order Count).

In AVC compressed image information, Direct Modes can be defined on a 16×16 pixel macroblock basis or an 8×8 pixel block basis.

[Competition Among Motion Vectors]

There is a method suggested for improving motion vector encoding using median predictions as described above with reference to FIG. 8 (e.g., Joel Jung and Guillaume Laroche, “Competition-Based Scheme for Motion Vector Selection and Coding”, VCEG-AC06, ITU-Telecommunications Standardization Sector STUDY GROUP 16 Question 6 Video Coding Experts Group (VCEG) 29th Meeting: Klagenfurt, Austria, 17-18 Jul., 2006).

That is, in addition to a “Spatial Predictor” determined through a median prediction, one of a “Temporal Predictor” and a “Spatio-Temporal Predictor” described below can be adaptively used as predicted motion vector information.

Specifically, in FIG. 11, “mv_{col}” represents the motion vector information about a co-located block (a block having the same x-y coordinates as the current block in a reference image) of the current block, and “mvₜₖ” (k being one of 0 through 8) represents the motion vector information about an adjacent block. The predicted motion vector information (Predictor) about each block is defined as shown in the following equations (38) through (40).

Temporal Predictor:

[Mathematical Formula 35]

mvₜₘ₅=median{mv_{col},moₜ₀, . . . ,mvₜ₃} (38)

[Mathematical Formula 36]

mvₜₘ₉=median{mv_{col},moₜ₀, . . . ,mvₜ₈} (39)

### Spatio-Temporal Predictor:

[Mathematical Formula 37]

mvₛₚₜ=median{mv_{col},mv_{col},mvₐ,mv_{b},mv_{c}} (40)

In the image encoding device 100, the cost function values for respective blocks are calculated by using the predicted motion vector information about the respective blocks, and optimum predicted motion vector information is selected. Through the compressed image information, a flag indicating the information as to which predicted motion vector information has been used is transmitted for each block.

[Motion Partition Merging]

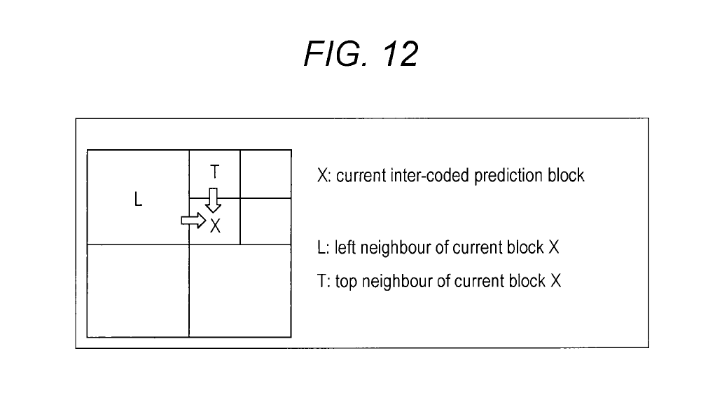

Meanwhile, as a motion information encoding method, there is a suggested method called Motion Partition Merging (the Merge Mode) as shown in FIG. 12. According to this method, the two flags, a Merge Flag and a Merge Left Flag, are transmitted as merge information that is information related to the Merge Mode. When the Merge Flag is 1, the motion information about the current region X is the same as the motion information about an adjacent region T that is located adjacent to the top edge of the current region, or the motion information about an adjacent region L that is located adjacent to the left edge of the current region. At this point, the Merge Left Flag is included in merge information, and is transmitted. When the Merge Flag is 0, the motion information about the current region X differs from both the motion information about the adjacent region T and the motion information about the adjacent region L. In this case, the motion information about the current region X is transmitted.

When the motion information about the current region X is the same as the motion information about the adjacent region L, the Merge Flag is 1, and the Merge Left Flag is 1. When the motion information about the current region X is the same as the motion information about the adjacent region T, the Merge Flag is 1, and the Merge Left Flag is 0.

[Block Distortion]

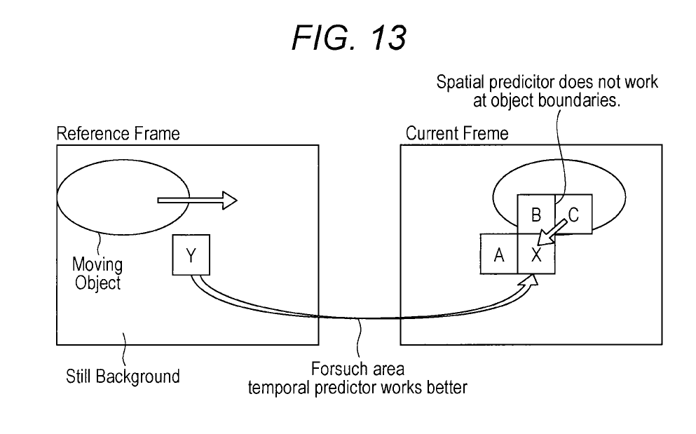

In the above described MV competition and the Merge Mode, a Temporal Predictor is likely to be selected in a still region, and a Spatial Predictor is likely to be selected in a moving object region, as illustrated in FIG. 13. Therefore, block distortion is likely to be observed on a boundary between a PU (Prediction Unit) for which a Temporal Predictor is selected and a PU for which a Spatial Predictor is selected.

In a deblocking process of AVC or HEVC, however, such features are not taken into consideration, and there is a possibility that block distortion is not thoroughly removed from decoded images through the deblocking process. As a result, the quality of decoded images might become lower.

On the other hand, the image encoding device 100 shown in FIG. 1 compares the predictor of the current region being processed with the predictor of an adjacent region, to detect regions from which block distortion is easily spotted. The deblocking filtering strength is increased for such regions. More specifically, the image encoding device 100 performs deblocking filtering with higher strength on the current region having a different optimum predictor that differs from those of adjacent regions. By doing so, the image encoding device 100 can reduce block distortion more accurately, and reduce degradation of the quality of decoded images.

This aspect will be described below in greater detail.

[Motion Vector Encoding Unit, Region Determination Unit, Boundary Control Unit, and Deblocking Filter]

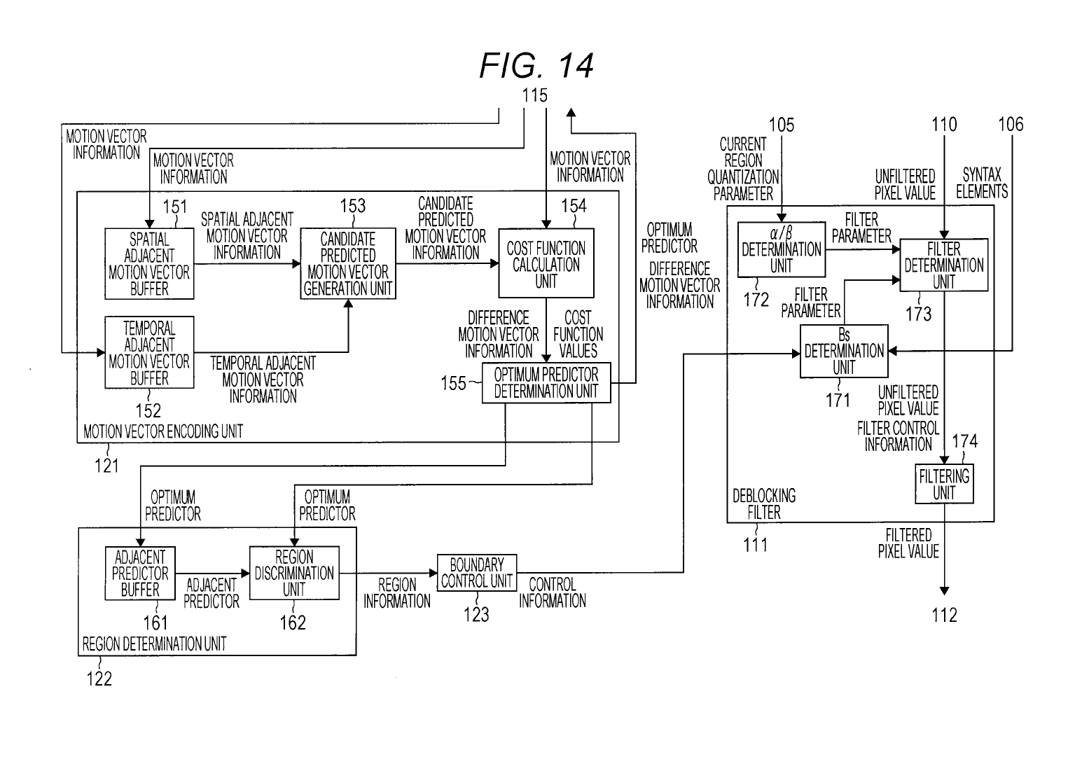

FIG. 14 is a block diagram showing typical example structures of the motion vector encoding unit 121, the region determination unit 122, and the deblocking filter 111.

As shown in FIG. 14, the motion vector encoding unit 121 includes a spatial adjacent motion vector buffer 151, a temporal adjacent motion vector buffer 152, a candidate predicted motion vector generation unit 153, a cost function calculation unit 154, and an optimum predictor determination unit 155.

The region determination unit 122 includes an adjacent predictor buffer 161 and a region discrimination unit 162.

Further, the deblocking filter 111 includes a Bs determination unit 171, an α/β determination unit 172, a filter determination unit 173, and a filtering unit 174.

The spatial adjacent motion vector buffer 151 of the motion vector encoding unit 121 acquires and stores motion vector information supplied from the motion prediction/compensation unit 115. In response to a request from the candidate predicted motion vector generation unit 153, the spatial adjacent motion vector buffer 151 supplies the stored motion vector information as spatial adjacent motion vector information to the candidate predicted motion vector generation unit 153. That is, in a process for another PU in the same frame (the current frame) as the PU corresponding to the motion vector information, the spatial adjacent motion vector buffer 151 supplies the stored motion vector information to the candidate predicted motion vector generation unit 153.

The temporal adjacent motion vector buffer 152 acquires and stores motion vector information supplied from the motion prediction/compensation unit 115. In response to a request from the candidate predicted motion vector generation unit 153, the temporal adjacent motion vector buffer 152 supplies the stored motion vector information as temporal adjacent motion vector information to the candidate predicted motion vector generation unit 153. That is, in a process for a PU in a reference frame that is processed after the frame of the PU corresponding to the motion vector information, the temporal adjacent motion vector buffer 152 supplies the stored motion vector information to the candidate predicted motion vector generation unit 153.

Using the motion vector information about a PU (an adjacent PU) spatially or temporally adjacent to the current PU being processed, the candidate predicted motion vector generation unit 153 generates a candidate for a predicted motion vector (candidate predicted motion vector information), and supplies the candidate predicted motion vector information to the cost function calculation unit 154.

Specifically, the candidate predicted motion vector generation unit 153 generates candidate predicted motion vector information about Spatial Predictors and candidate predicted motion vector information about Temporal Predictors (including Spatio-Temporal Predictors). For example, the candidate predicted motion vector generation unit 153 acquires motion vectors (spatial adjacent motion vector information) of adjacent PUs of the current frame from the spatial adjacent motion vector buffer 151, and generates candidate predicted motion vector information through a median prediction or a merging process. Also, for example, the candidate predicted motion vector generation unit 153 acquires motion vector information (temporal adjacent motion vector information) about adjacent PUs of reference frames from the temporal adjacent motion vector buffer 152, and generates candidate predicted motion vector information through a median prediction or a merging process.

The cost function calculation unit 154 acquires the motion vector information about the current PU from the motion prediction/compensation unit 115, determines the difference value (difference motion vector information) between the motion vector information about the current PU and each piece of the candidate predicted motion vector information, and calculates the cost function value of the difference motion vector information. The cost function calculation unit 154 supplies the calculated cost function values and the difference motion vector information to the optimum predictor determination unit 155.

The optimum predictor determination unit 155 determines the predictor with the smallest cost function value to be the optimum predictor among the candidates. The optimum predictor determination unit 155 supplies information indicating the determined optimum predictor (hereinafter also referred to simply as the optimum predictor) and the difference motion vector information generated by using the predicted motion vector information about the optimum predictor, to the motion prediction/compensation unit 115. The motion prediction/compensation unit 115 determines an optimum inter prediction mode among candidates including the mode of the optimum predictor.

The optimum predictor determination unit 155 further supplies the optimum predictor to the region determination unit 122 (the adjacent predictor buffer 161 and the region discrimination unit 162).

The adjacent predictor buffer 161 of the region determination unit 122 acquires and stores the optimum predictor supplied from the optimum predictor determination unit 155. In accordance with a request from the region discrimination unit 162, the adjacent predictor buffer 161 supplies the stored optimum predictor as information indicating the predictor of an adjacent PU (hereinafter also referred to as the adjacent predictor) to the region discrimination unit 162.

Acquiring the optimum predictor of the current PU being processed from the optimum predictor determination unit 155, the region discrimination unit 162 acquires the adjacent predictor corresponding to the current PU from the adjacent predictor buffer 161. That is, the region discrimination unit 162 acquires the information indicating the optimum predictor of an adjacent PU in the same frame as the current PU.

The region discrimination unit 162 discriminates the feature related to block distortion from the other features of the current PU to be subjected to a deblocking filtering process. More specifically, the region discrimination unit 162 determines whether the adjacent predictor is the same as the optimum predictor of the current PU. As described above, the MV competition or processing in the Merge Mode is performed in the motion vector encoding unit 121. Therefore, a Spatial Predictor or a Temporal Predictor (or a Spatio-Temporal Predictor) is applied to each PU. When a Spatial Predictor is applied to both the current PU and the adjacent PU, or when a Temporal Predictor (or a Spatio-Temporal Predictor) is applied to both the current PU and the adjacent PU, the region discrimination unit 162 determines that the adjacent predictor is the same as the optimum predictor of the current PU.

When bi-prediction is applied to the current PU, the region discrimination unit 162 performs determination using a predictor related to the List 0 predictor. Although it is of course possible to use a predictor related to the List 1 predictor, List 0 normally comes first in a bit stream, and List 1 does not exist in some cases. Therefore, it is preferable to use a predictor of the List 0 predictor.

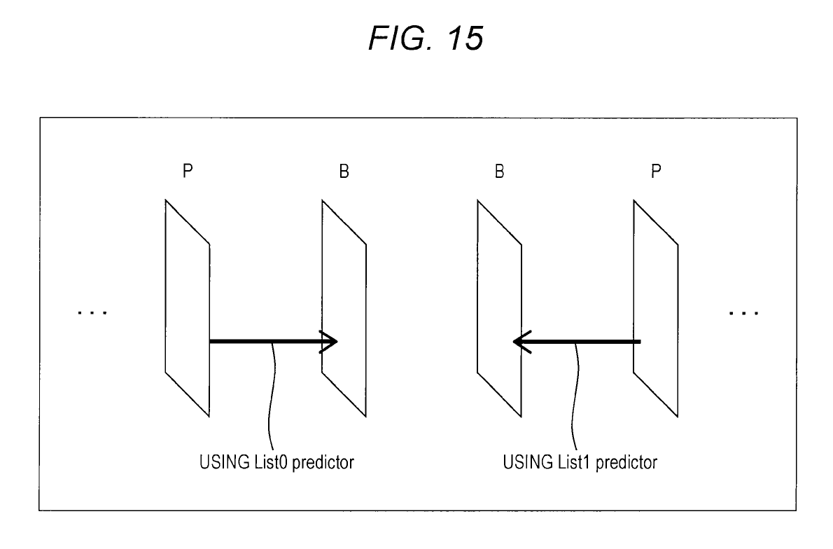

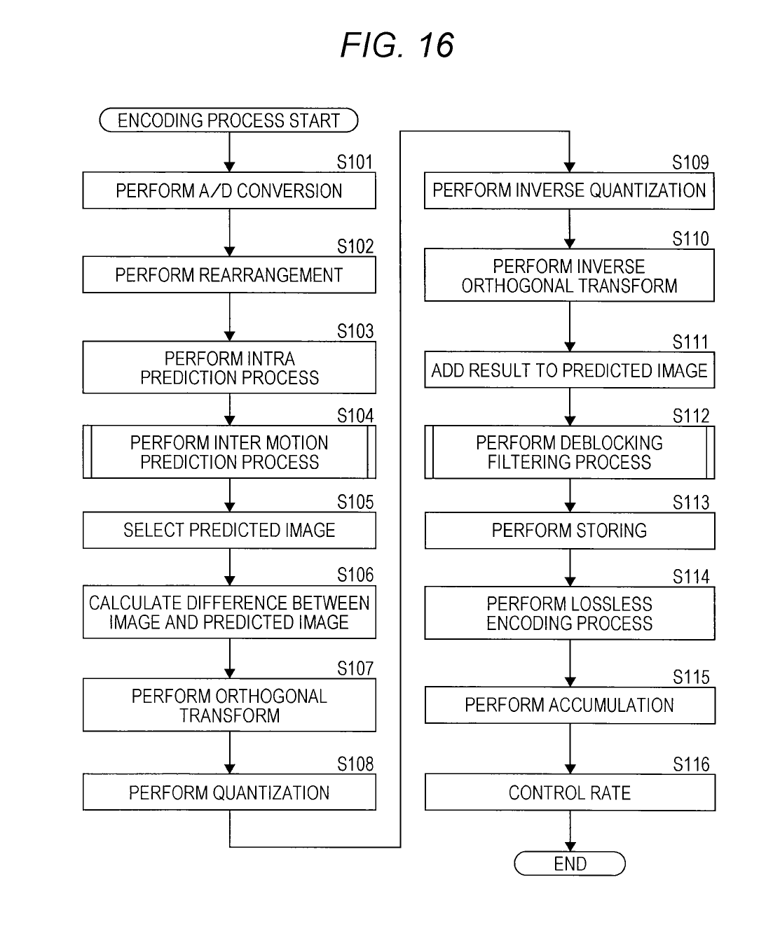

The region discrimination unit 162 may adaptively select the List 0 predictor or the List 1 predictor in accordance with the GOP (Group of Picture) structure. For example, the region discrimination unit 162 may select a predictor using the reference frame closest to the current frame being processed. In each example GOP structure illustrated in FIG. 15, the predictor using the P-picture as the reference frame, which is the closest to the B-picture as the current picture, is selected.

The region discrimination unit 162 supplies the determination result as region information to the boundary control unit 123.

Acquiring the region information including the information indicating the feature related to block distortion in the current PU from the region discrimination unit 162, the boundary control unit 123 controls the filtering strength of the deblocking filter 111 in accordance with the feature. More specifically, the boundary control unit 123 performs control to set a higher deblocking filtering strength on a region where block distortion is likely to be observed, or on a PU that has been determined, by the region discrimination unit 162, to have a different predictor from the predictor applied to the adjacent PU.

The boundary control unit 123 adjusts the deblocking filtering strength by having the Bs value of the deblocking filter corrected. While the Bs value may be adjusted by any appropriated method, the Bs value may be adjusted to “Bs+1”, for example, as opposed to a conventional method. Also, the Bs value may be forced to be “Bs=4”, regardless of a value according to a conventional method.

As for a PU determined to have the same predictor as an adjacent PU, the boundary control unit 123 does not correct the Bs value (or maintains the value determined by a conventional method).

The boundary control unit 123 realizes adjustment of the deblocking filtering strength by supplying control information indicating an instruction to correct the Bs value to the Bs determination unit 171 of the deblocking filter 111.

The Bs determination unit 171 of the deblocking filter 111 determines the Bs value based on various kinds of syntax elements supplied from the lossless encoding unit 106, such as intra/inter mode information and motion vector information.

The Bs determination unit 171 also corrects the Bs value, where appropriate, in accordance with the control information supplied from the boundary control unit 123. Specifically, the Bs determination unit 171 sets a higher deblocking filtering strength on a PU that has been determined, by the region discrimination unit 162, to have a different predictor from the predictor applied to the adjacent PU. Although any appropriate specific method may be used, the Bs value may be adjusted to “Bs+1”, or may be set as “Bs=4”, for example.

The Bs determination unit 171 supplies the Bs value corrected in this manner as a filter parameter to the filter determination unit 173.

The α/β determination unit 172 determines the values of α and β by using the quantization parameter of the current PU (the current region quantization parameter) supplied from the quantization unit 105. The α/β determination unit 172 supplies the determined α and β as filter parameters to the filter determination unit 173.

Using the filter parameters supplied from the Bs determination unit 171 and the α/β determination unit 172, the filter determination unit 173 determines what kind of filtering process is to be performed on a reconstructed image (an unfiltered pixel value) supplied from the arithmetic operation unit 110. The filter determination unit 173 supplies the control information (filter control information), as well as the unfiltered pixel value, to the filtering unit 174.

The filtering unit 174 performs a deblocking filtering process on the unfiltered pixel value supplied from the filter determination unit 173, in accordance with the filter control information. The filtering unit 174 supplies and stores the resultant filtered pixel value into the frame memory 112.

As described above, the region determination unit 122 compares the predictor of the current PU with the predictor of an adjacent PU, to detect a PU in which block distortion is likely to be observed. The boundary control unit 123 then performs control to set a higher deblocking filtering strength for the PU in which block distortion is likely to be observed. Under the control thereof, the Bs determination unit 171 corrects the Bs value. As a result, the filtering unit 174 can perform a deblocking filtering process with an increased strength for the PU in which block distortion is likely to be observed. That is, the deblocking filter 111 can reduce block distortion more accurately. Accordingly, the image encoding device 100 can reduce degradation of the quality of decoded images.

[Flow of an Encoding Process]

Next, the flow of each process to be performed by the above described image encoding device 100 is described. Referring first to the flowchart shown in FIG. 16, an example flow of an encoding process is described.

In step S101, the A/D converter 101 performs an A/D conversion on an input image. In step S102, the screen rearrangement buffer 102 stores the image subjected to the A/D conversion, and rearranges the respective pictures in encoding order, instead of displaying order.

In step S103, the intra prediction unit 114 performs an intra prediction process in intra prediction modes. In step S104, the motion prediction/compensation unit 115 and the motion vector encoding unit 121 perform an inter motion prediction process to perform motion predictions and motion compensation in inter prediction modes.

In step S105, the predicted image selection unit 116 determines an optimum prediction mode based on the respective cost function values that are output from the intra prediction unit 114 and the motion prediction/compensation unit 115. That is, the predicted image selection unit 116 selects the predicted image generated by the intra prediction unit 114 or the predicted image generated by the motion prediction/compensation unit 115.

In step S106, the arithmetic operation unit 103 calculates the difference between the image rearranged by the processing in step S102 and the predicted image selected by the processing in step S105. The data amount of the difference data is smaller than that of the original image data. Accordingly, the data amount can be made smaller than in a case where an image is directly encoded.

In step S107, the orthogonal transform unit 104 performs an orthogonal transform on the difference information generated by the processing in step S106. Specifically, an orthogonal transform such as a discrete cosine transform or a Karhunen-Loeve transform is performed, and a transform coefficient is output. In step S108, the quantization unit 105 quantizes the orthogonal transform coefficient obtained by the processing in step S107.

The difference information quantized by the processing in step S108 is locally decoded in the following manner. In step S109, the inverse quantization unit 108 inversely quantizes the orthogonal transform coefficient quantized by the processing in step S108, by a method compatible with the quantization performed in step S108. In step S110, the inverse orthogonal transform unit 109 performs an inverse orthogonal transform on the orthogonal transform coefficient obtained by the processing in step S109, by a method compatible with the processing in step S107.

In step S111, the arithmetic operation unit 110 adds the predicted image to the locally decoded difference information, and generates a locally decoded image (an image corresponding to the input to the arithmetic operation unit 103). In step S112, the region determination unit 122, the boundary control unit 123, and the deblocking filter 111 perform a deblocking filtering process on the image generated by the processing in step S111. As a result, block distortion and the like are removed.

In step S113, the frame memory 112 stores the image subjected to the block distortion removal and the like by the processing in step S112. It should be noted that images that have not been subjected to filtering processes by the deblocking filter 111 are also supplied from the arithmetic operation unit 110, and are stored into the frame memory 112. The images stored in the frame memory 112 are used in the processing in step S103 and the processing in step S104.

In step S114, the lossless encoding unit 106 encodes the transform coefficient quantized by the processing in step S108, and generates encoded data. That is, lossless encoding such as variable-length encoding or arithmetic encoding is performed on the difference image (a second-order difference image in the case of an inter prediction).

The lossless encoding unit 106 also encodes the information about the prediction mode of the predicted image selected by the processing in step S105, and adds the encoded information to the encoded data obtained by encoding the difference image. When an intra prediction mode is selected, for example, the lossless encoding unit 106 encodes intra prediction mode information. When an inter prediction mode is selected, for example, the lossless encoding unit 106 encodes inter prediction mode information. The information is added as header information or the like to (or is multiplexed with) the encoded data.

In step S115, the accumulation buffer 107 accumulates the encoded data generated by the processing in step S114. The encoded data accumulated in the accumulation buffer 107 is read out when necessary, and is transmitted to the device on the decoding side via a desired transmission path (including not only a communication channel but also a storage medium or the like).

In step S116, based on the compressed images accumulated in the accumulation buffer 107 by the processing in step S115, the rate control unit 117 controls the quantization operation rate of the quantization unit 105 so as not to cause an overflow or underflow.

When the processing in step S116 is completed, the encoding process comes to an end.

[Flow of the Inter Motion Prediction Process]

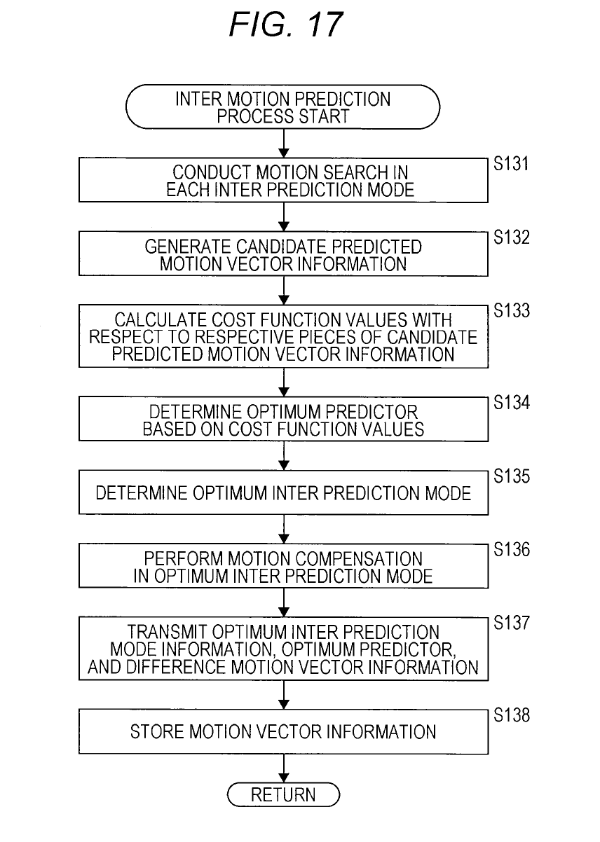

Referring now to the flowchart in FIG. 17, an example flow of the inter motion prediction process to be performed in step S104 in FIG. 16 is described.

When the inter motion prediction process is started, the motion prediction/compensation unit 115 in step S131 conducts a motion search in each inter prediction mode, and generates motion vector information.

In step S132, the candidate predicted motion vector generation unit 153 generates candidate predicted motion vector information about each predictor.

In step S133, the cost function calculation unit 154 determines difference motion vector information between the motion vector information about the current PU obtained by the processing in step S131 and each piece of the candidate predicted motion vector information obtained by the processing in step S132, and calculates the cost function value thereof.

In step S134, the optimum predictor determination unit 155 determines the optimum predictor to be the predictor with the smallest one of the cost function values calculated in step S133.

In step S135, the motion prediction/compensation unit 115 adds the mode of the optimum predictor determined in step S134 to the candidates, and determines the optimum inter prediction mode. In step S136, the motion prediction/compensation unit 115 performs motion compensation in the optimum inter prediction mode determined by the processing in step S135, and generates a predicted image. In step S137, the motion prediction/compensation unit 115 supplies, as appropriate, the optimum inter prediction mode information, the optimum predictor, and the difference motion vector information to the lossless encoding unit 106, which then transmits those pieces of information.

In step S138, the spatial adjacent motion vector buffer 151 and the temporal adjacent motion vector buffer 152 store the motion vector information about the current PU obtained by the processing in step S131. This motion vector information is used in processing other PUs.

After the processing in step S138 is completed, the spatial adjacent motion vector buffer 151 and the temporal adjacent motion vector buffer 152 end the inter motion prediction process, and the process returns to FIG. 16.

[Flow of the Deblocking Filtering Process]

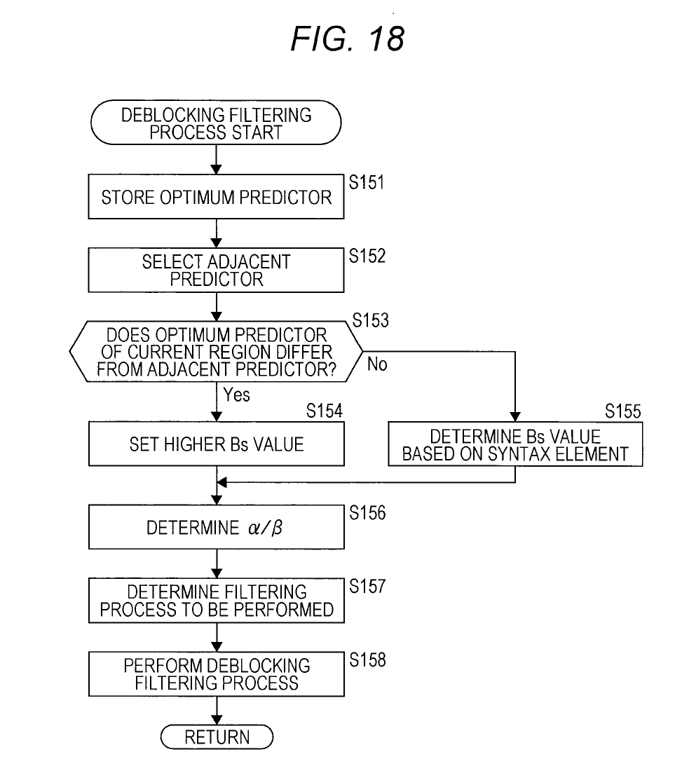

Referring now to the flowchart shown in FIG. 18, an example flow of the deblocking filtering process to be performed in step S112 in FIG. 16 is described.

When the deblocking filtering process is started, the adjacent predictor buffer 161 in step S151 stores the optimum predictor of the current PU determined in step S134 in FIG. 17.

In step S152, the region discrimination unit 162 selects and acquires an adjacent predictor corresponding to the current PU from the predictors stored in the adjacent predictor buffer 161.

In step S153, the region discrimination unit 162 determines whether the optimum predictor of the current PU differs from the adjacent predictor.

When determining that the two predictors differ from each other, the region discrimination unit 162 moves the process on to step S154. For example, in a case where the region discrimination unit 162 determines that the optimum predictor of the current PU is a Spatial Predictor and the adjacent predictor is a Temporal Predictor (or a Spatio-Temporal Predictor), or where the region discrimination unit 162 determines that the optimum predictor of the current PU is a Temporal Predictor (or a Spatio-Temporal Predictor) and the adjacent predictor is a Spatial Predictor, the region discrimination unit 162 moves the process on to step S154.

In step S154, the boundary control unit 123 performs control to set a greater Bs value. Under the control thereof, the Bs determination unit 171 sets a greater Bs value than a Bs value determined based on syntax elements. For example, the Bs determination unit 171 adds “+1” to a Bs value determined based on syntax elements. Alternatively, the Bs determination unit 171 sets the Bs value to “Bs=4”, for example, regardless of a value determined based on syntax elements. After setting a Bs value, the Bs determination unit 171 moves the process on to step S156.

In a case where the optimum predictor of the current PU and the adjacent predictor are determined to be the same in step S153, the region discrimination unit 162 moves the process on to step S155. For example, in a case where the region discrimination unit 162 determines that the optimum predictor of the current PU and the adjacent predictor are Spatial Predictors, or where the region discrimination unit 162 determines that the optimum predictor of the current PU and the adjacent predictor are Temporal Predictors (or Spatio-Temporal Predictors), the region discrimination unit 162 moves the process on to step S155.

In step S155, the boundary control unit 123 performs control to maintain a Bs value determined by a conventional method. Under the control thereof, the Bs determination unit 171 sets a Bs value based on syntax elements. After setting a Bs value, the Bs determination unit 171 moves the process on to step S156.

In step S156, the α/β determination unit 172 determines α and β based on a quantization parameter and the like.

In step S157, based on the respective parameters determined in steps S154 through S156, the filter determination unit 173 determines what kind of filtering process is to be performed on the current PU on a block boundary.

In step S158, the filtering unit 174 performs a deblocking filtering process on the current PU in accordance with the result of the determination.

When the processing in step S158 is completed, the filtering unit 174 ends the deblocking filtering process.

By performing the respective processes as described above, the image encoding device 100 can reduce block distortion more accurately, and reduce degradation of the quality of decoded images.

[Image Decoding Device]

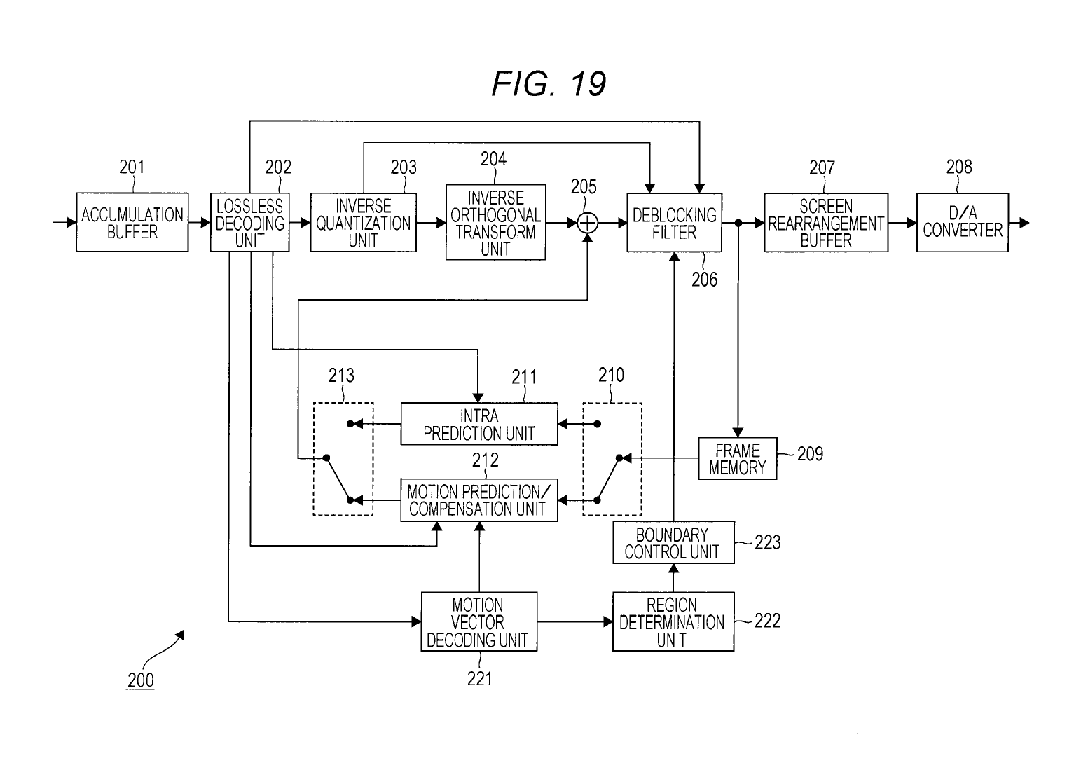

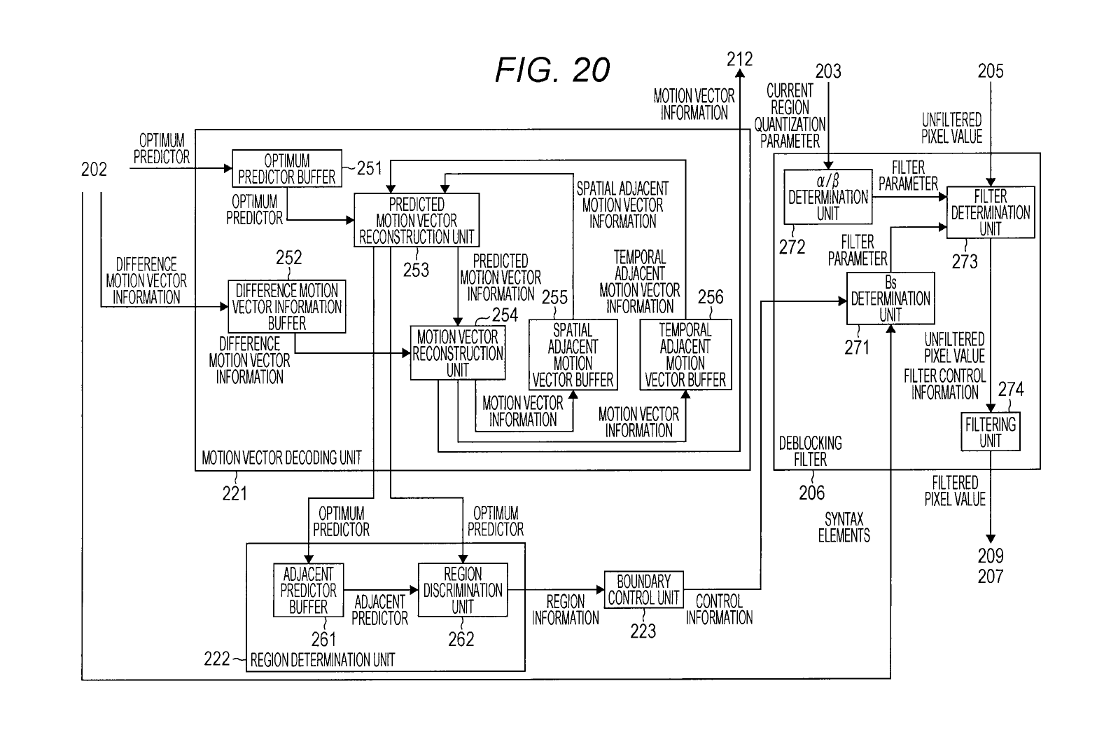

FIG. 19 is a block diagram showing a typical example structure of an image decoding device that is an image processing device to which the present technique is applied. The image decoding device 200 shown in FIG. 19 is compatible with the above described image encoding device 100, and generates a decoded image by correctly decoding a bit stream (encoded data) generated by the image encoding device 100 encoding image data.

As shown in FIG. 19, the image decoding device 200 includes an accumulation buffer 201, a lossless decoding unit 202, an inverse quantization unit 203, an inverse orthogonal transform unit 204, an arithmetic operation unit 205, a deblocking filter 206, a screen rearrangement buffer 207, and a D/A converter 208. The image decoding device 200 also includes a frame memory 209, a selection unit 210, an intra prediction unit 211, a motion prediction/compensation unit 212, and a selection unit 213.

The image decoding device 200 further includes a motion vector decoding unit 221, a region determination unit 222, and a boundary control unit 223.

The accumulation buffer 201 accumulates encoded data that is transmitted thereto, and supplies the encoded data to the lossless decoding unit 202 at a predetermined time. The lossless decoding unit 202 decodes information that has been encoded by the lossless encoding unit 106 shown in FIG. 1 and has been supplied from the accumulation buffer 201, by a method compatible with the encoding method used by the lossless encoding unit 106. The lossless decoding unit 202 supplies quantized coefficient data of the difference image obtained as a result of the decoding, to the inverse quantization unit 203.

The lossless decoding unit 202 also refers to the information about the optimum prediction mode obtained by decoding the encoded data, and determines whether an intra prediction mode has been selected as the optimum prediction mode and whether an inter prediction mode has been selected as the optimum prediction mode. That is, the lossless decoding unit 202 determines whether the prediction mode used for the transmitted encoded data is an intra prediction mode and whether the prediction mode is an inter prediction mode.

Based on a result of the determination, the lossless decoding unit 202 supplies the information about the prediction mode to the intra prediction unit 211 or the motion prediction/compensation unit 212. In a case where an intra prediction mode has been selected as the optimum prediction mode in the image encoding device 100, for example, the lossless decoding unit 202 supplies intra prediction information that is supplied from the encoding side and relates to the selected intra prediction mode, to the intra prediction unit 211. In a case where an inter prediction mode has been selected as the optimum prediction mode in the image encoding device 100, for example, the lossless decoding unit 202 supplies inter prediction information that is supplied from the encoding side and relates to the selected inter prediction mode, to the motion prediction/compensation unit 212.

The lossless decoding unit 202 further supplies information related to the MV competition or the Merge Mode, such as an optimum predictor and difference motion vector information added to (multiplexed with) encoded data, to the motion vector decoding unit 221.

The lossless decoding unit 202 also supplies syntax-element-related information such as intra/inter mode information and motion vector information to the deblocking filter 206.

The inverse quantization unit 203 inversely quantizes the quantized coefficient data obtained through the decoding by the lossless decoding unit 202, by a method (the same method as that used by the inverse quantization unit 108) compatible with the quantization method used by the quantization unit 105 shown in FIG. 1. The inverse quantization unit 203 supplies the inversely-quantized coefficient data to the inverse orthogonal transform unit 204.

The inverse quantization unit 203 also supplies information related to the quantization parameter used in the inverse quantization to the deblocking filter 206.

The inverse orthogonal transform unit 204 performs an inverse orthogonal transform on the coefficient data supplied from the inverse quantization unit 203, by a method compatible with the orthogonal transform method used by the orthogonal transform unit 104 shown in FIG. 1. Through this inverse orthogonal transform process, the inverse orthogonal transform unit 204 obtains a difference image corresponding to the difference image not yet subjected to the orthogonal transform in the image encoding device 100.

The difference image obtained through the inverse orthogonal transform is supplied to the arithmetic operation unit 205. A predicted image is also supplied to the arithmetic operation unit 205 from the intra prediction unit 211 or the motion prediction/compensation unit 212 via the selection unit 213.

The arithmetic operation unit 205 adds the difference image to the predicted image, and obtains a reconstructed image corresponding to the image from which the predicted image has not yet been subtracted by the arithmetic operation unit 103 of the image encoding device 100. The arithmetic operation unit 205 supplies the reconstructed image to the deblocking filter 206.

The deblocking filter 206 removes block distortion by performing a deblocking filtering process on the supplied reconstructed image, and generates a decoded image. Based on various kinds of information supplied from the lossless decoding unit 202, the inverse quantization unit 203, and the boundary control unit 223, the deblocking filter 206 performs a process basically the same as that performed by the deblocking filter 111 in FIG. 1, to determine how a deblocking filtering process is to be performed, and then performs a filtering process. A loop filtering process using a Wiener filter may be further performed on the result of the deblocking filtering process, and other filtering processes may be further performed.

The deblocking filter 206 supplies the decoded image as the result of the filtering process to the screen rearrangement buffer 207 and the frame memory 209. The filtering process by the deblocking filter 206 can be skipped.

The screen rearrangement buffer 207 performs rearrangement on the supplied decoded image. Specifically, the frame sequence rearranged in the encoding order by the screen rearrangement buffer 102 shown in FIG. 1 is rearranged in the original displaying order. The D/A converter 208 performs a D/A conversion on the decoded image supplied from the screen rearrangement buffer 207, and outputs the decoded image to a display (not shown) to display the image.

The frame memory 209 stores the supplied reconstructed image and the supplied decoded image. At a predetermined time or in accordance with a request from outside such as from the intra prediction unit 211 or the motion prediction/compensation unit 212, the frame memory 209 supplies the stored reconstructed image or the stored decoded image to the intra prediction unit 211 or the motion prediction/compensation unit 212 via the selection unit 210.

The intra prediction unit 211 performs an intra prediction based on the intra prediction information supplied from the lossless decoding unit 202, and generates a predicted image. Based on the intra prediction information supplied from the lossless decoding unit 202, the intra prediction unit 211 performs an intra prediction in the same mode as the mode used in the process performed by the intra prediction unit 114 in FIG. 1, only on the region where a predicted image has been generated through an intra prediction at the time of encoding.

The motion prediction/compensation unit 212 performs an inter prediction based on the inter prediction information supplied from the lossless decoding unit 202, and generates a predicted image. Based on the inter prediction information supplied from the lossless decoding unit 202, the motion prediction/compensation unit 212 performs an inter prediction in the same mode as the mode used in the process performed by the motion prediction/compensation unit 115 in FIG. 1, only on the region where an inter prediction has been performed at the time of encoding. The motion prediction/compensation unit 212 also causes the motion vector decoding unit 221 to perform a process related to the MV competition or the Merge Mode.

For each prediction processing unit region, the intra prediction unit 211 or the motion prediction/compensation unit 212 supplies a generated predicted image to the arithmetic operation unit 205 via the selection unit 213. The selection unit 213 supplies a predicted image supplied from the intra prediction unit 211 or a predicted image supplied from the motion prediction/compensation unit 212, to the arithmetic operation unit 205.

Based on the information supplied from the lossless decoding unit 202, the motion vector decoding unit 221 performs a process involving the MV competition or the Merge Mode to reconstruct the motion vectors, and supplies the motion vectors to the motion prediction/compensation unit 212. The motion vector decoding unit 221 also supplies information related to the optimum predictor used in the current PU (the optimum predictor) to the region determination unit 222.

Using the optimum predictor supplied from the motion vector decoding unit 221, the region determination unit 222 performs a process that is basically the same as that performed by the region determination unit 122 in FIG. 1, and determines whether the current PU is a PU in which block distortion is likely to be observed. The region determination unit 222 supplies the result of the determination to the boundary control unit 223.

The boundary control unit 223 performs a process that is basically the same as the process performed by the boundary control unit 123 in FIG. 1, and controls the settings of the deblocking filter 206 in accordance with the result of the determination performed by the region determination unit 222. Under the control of the boundary control unit 223, the deblocking filter 206 adjusts its filtering strength, and performs a deblocking filtering process.

[Motion Vector Decoding Unit, Region Determination Unit, Boundary Control Unit, and Deblocking Filter]

FIG. 20 is a block diagram showing typical example structures of the motion vector decoding unit 221, the region determination unit 222, and the deblocking filter 206.

As shown in FIG. 20, the motion vector decoding unit 221 includes an optimum predictor buffer 251, a difference motion vector information buffer 252, a predicted motion vector reconstruction unit 253, a motion vector reconstruction unit 254, a spatial adjacent motion vector buffer 255, and a temporal adjacent motion vector buffer 256.

The region determination unit 222 includes an adjacent predictor buffer 261 and a region discrimination unit 262.

Further, the deblocking filter 206 includes a Bs determination unit 271, an α/β determination unit 272, a filter determination unit 273, and a filtering unit 274.

The optimum predictor buffer 251 of the motion vector decoding unit 221 acquires and stores the optimum predictor supplied from the lossless decoding unit 202. In accordance with a request from the predicted motion vector reconstruction unit 253, the optimum predictor buffer 251 supplies the stored optimum predictor to the predicted motion vector reconstruction unit 253.

The difference motion vector information buffer 252 acquires and stores the difference motion vector information supplied from the lossless decoding unit 202. In accordance with a request from the motion vector reconstruction unit 254, the difference motion vector information buffer 252 supplies the stored difference motion vector information to the motion vector reconstruction unit 254.

The predicted motion vector reconstruction unit 253 acquires the optimum predictor of the current PU as the current region from the optimum predictor buffer 251. The predicted motion vector reconstruction unit 253 acquires the motion vector information about an adjacent PU corresponding to the optimum predictor from the spatial adjacent motion vector buffer 255 or the temporal adjacent motion vector buffer 256.

If the optimum predictor is a Spatial Predictor, for example, the predicted motion vector reconstruction unit 253 acquires spatial adjacent motion vector information from the spatial adjacent motion vector buffer 255. If the optimum predictor is a Temporal Predictor (or a Spatio-Temporal Predictor), for example, the predicted motion vector reconstruction unit 253 acquires temporal adjacent motion vector information from the temporal adjacent motion vector buffer 256.

Using the acquired adjacent motion vector information (spatial adjacent motion vector information or temporal adjacent motion vector information), the predicted motion vector reconstruction unit 253 reconstructs a predicted value (predicted motion vector information) of the motion vectors of the current PU. This predicted motion vector information corresponds to the predicted motion vector information about the optimum predictor generated by the candidate predicted motion vector generation unit 153 in FIG. 14.

The predicted motion vector reconstruction unit 253 supplies the reconstructed predicted motion vector information to the motion vector reconstruction unit 254. The predicted motion vector reconstruction unit 253 supplies the optimum predictor to the adjacent predictor buffer 261 and the region discrimination unit 262 of the region determination unit 222.

The motion vector reconstruction unit 254 acquires the difference motion vector information about the current PU from the difference motion vector information buffer 252, and acquires the predicted motion vector information about the current PU from the predicted motion vector reconstruction unit 253. The motion vector reconstruction unit 254 reconstructs the motion vector information about the current PU by adding the predicted motion vector information to the difference motion vector information. This motion vector information corresponds to the motion vector information supplied from the motion prediction/compensation unit 115 to the motion vector encoding unit 121 in FIG. 14.

The motion vector reconstruction unit 254 supplies the reconstructed motion vector information about the current PU to the motion prediction/compensation unit 212. Using this motion vector information, the motion prediction/compensation unit 212 performs inter predictions. Accordingly, the motion prediction/compensation unit 212 can also perform inter predictions involving the MV competition or the Merge Mode by a method compatible with the processing performed by the motion prediction/compensation unit 115 shown in FIG. 1.

The motion vector reconstruction unit 254 also supplies the reconstructed motion vector information about the current PU to the spatial adjacent motion vector buffer 255 and the temporal adjacent motion vector buffer 256.

The spatial adjacent motion vector buffer 255 acquires and stores the motion vector information supplied from the motion vector reconstruction unit 254. In accordance with a request from the predicted motion vector reconstruction unit 253, the spatial adjacent motion vector buffer 255 supplies the stored motion vector information as spatial adjacent motion vector information to the predicted motion vector reconstruction unit 253. That is, in a process for another PU in the same frame as the PU corresponding to the motion vector information, the spatial adjacent motion vector buffer 255 supplies the stored motion vector information to the predicted motion vector reconstruction unit 253.

The temporal adjacent motion vector buffer 256 acquires and stores the motion vector information supplied from the motion vector reconstruction unit 254. In accordance with a request from the predicted motion vector reconstruction unit 253, the temporal adjacent motion vector buffer 256 supplies the stored motion vector information as temporal adjacent motion vector information to the predicted motion vector reconstruction unit 253. That is, in a process for a PU in a different frame from the PU corresponding to the motion vector information, the temporal adjacent motion vector buffer 256 supplies the stored motion vector information to the predicted motion vector reconstruction unit 253.

Like the adjacent predictor buffer 161 shown in FIG. 14, the adjacent predictor buffer 261 of the region determination unit 222 acquires and stores the optimum predictor supplied from the predicted motion vector reconstruction unit 253. Like the adjacent predictor buffer 161 shown in FIG. 14, the adjacent predictor buffer 261 supplies the stored optimum predictor as an adjacent predictor to the region discrimination unit 262 in accordance with a request from the region discrimination unit 262.

Like the region discrimination unit 162 shown in FIG. 14, the region discrimination unit 262 acquires the optimum predictor about the current PU from the predicted motion vector reconstruction unit 253, and then acquires an adjacent predictor corresponding to the current PU from the adjacent predictor buffer 261.

Like the region discrimination unit 162 shown in FIG. 14, the region discrimination unit 262 discriminates the feature related to block distortion from the other features of the current CU to be subjected to a deblocking filtering process. More specifically, the region discrimination unit 262 determines whether the adjacent predictor is the same as the optimum predictor of the current PU. When a Spatial Predictor is applied to both the current PU and the adjacent PU, or when a Temporal Predictor (or a Spatio-Temporal Predictor) is applied to both the current PU and the adjacent PU, the region discrimination unit 262 determines that the adjacent predictor is the same as the optimum predictor of the current PU.

When bi-prediction is applied to the current PU, the region discrimination unit 262 selects one of the predictors, like the region discrimination unit 162. For example, if the region discrimination unit 162 performs determination using a predictor related to the List 0 predictor in such a case, the region discrimination unit 262 performs determination using a predictor related to the List 0 predictor, like the region discrimination unit 162.

If the region discrimination unit 162 adaptively selects the List 0 predictor or the List 1 predictor in accordance with the GOP structure, for example, the region discrimination unit 262 also performs adaptive selection in accordance with the GOP structure.

The region discrimination unit 262 supplies the determination result as region information to the boundary control unit 223.

The boundary control unit 223 performs a process that is basically the same as the process performed by the boundary control unit 123 shown in FIG. 14. Specifically, the boundary control unit 223 controls the filtering strength of the deblocking filter 111 based on the region information acquired from the region discrimination unit 262. More specifically, the boundary control unit 223 performs control to set a higher deblocking filtering strength on a region where block distortion is likely to be observed, or on a PU that has been determined, by the region discrimination unit 262, to have a different predictor from the predictor applied to the adjacent PU.

Like the boundary control unit 123, the boundary control unit 223 adjusts the deblocking filtering strength by having the Bs value of the deblocking filter corrected. While the Bs value may be adjusted by any appropriated method that is the same method as that used by the boundary control unit 123, the Bs value may be adjusted to “Bs+1”, for example, as opposed to a conventional method. Also, the Bs value may be forced to be “Bs=4”, regardless of a value according to a conventional method.

As for a PU determined to have the same predictor as an adjacent PU, the boundary control unit 223 does not correct the Bs value (or maintains the value determined by a conventional method).

The boundary control unit 223 realizes adjustment of the deblocking filtering strength by supplying control information indicating an instruction to correct the Bs value to the Bs determination unit 271 of the deblocking filter 206.

The respective components of the deblocking filter 206 perform basically the same processes as those performed by the deblocking filter 111 shown in FIG. 14. For example, like the Bs determination unit 171, the Bs determination unit 271 determines the Bs value based on various kinds of syntax elements, such as intra/inter mode information and motion vector information. However, the syntax elements are supplied from the lossless decoding unit 202.

Like the Bs determination unit Bs determination unit 171, the Bs determination unit 271 also sets a higher deblocking filtering strength on a PU that has been determined, by the region discrimination unit 162, to have a different predictor from the predictor applied to the adjacent PU, in accordance with the control information supplied from the boundary control unit 223. Although any appropriate specific method that is the same as the method used by the Bs determination unit 171 may be used, the Bs value may be adjusted to “Bs+1”, or may be set as “Bs=4”, for example.

The Bs determination unit 271 supplies the Bs value corrected in this manner as a filter parameter to the filter determination unit 273.

Like the α/β determination unit 172 shown in FIG. 14, the α/β determination unit 272 determines the values of α and β by using the quantization parameter of the current PU (the current region quantization parameter). However, this current region quantization parameter is supplied from the inverse quantization unit 203.

The α/β determination unit 272 supplies the determined α and β as filter parameters to the filter determination unit 273.

Using the filter parameters supplied from the Bs determination unit 271 and the α/β determination unit 272, the filter determination unit 273 determines what kind of filtering process is to be performed on a reconstructed image (an unfiltered pixel value), like the filter determination unit 173 shown in FIG. 14. However, this unfiltered pixel value is supplied from the arithmetic operation unit 205.

The filter determination unit 273 supplies the control information (filter control information), as well as the unfiltered pixel value, to the filtering unit 274.

Like the filtering unit 174 shown in FIG. 14, the filtering unit 274 performs a deblocking filtering process on the unfiltered pixel value supplied from the filter determination unit 273, in accordance with the filter control information. The filtering unit 274 supplies the resultant filtered pixel value to the frame memory 209 and the screen rearrangement buffer 207.

As described above, the region determination unit 222 compares the predictor of the current PU with the predictor of an adjacent PU, to detect a PU in which block distortion is likely to be observed. The boundary control unit 223 then performs control to set a higher deblocking filtering strength for the PU in which block distortion is likely to be observed. Under the control thereof, the Bs determination unit 271 corrects the Bs value. As a result, the filtering unit 274 can perform a deblocking filtering process with an increased strength for the PU in which block distortion is likely to be observed. That is, the deblocking filter 206 can reduce block distortion more accurately. Accordingly, the image decoding device 200 can reduce degradation of the quality of decoded images.

[Flow of a Decoding Process]

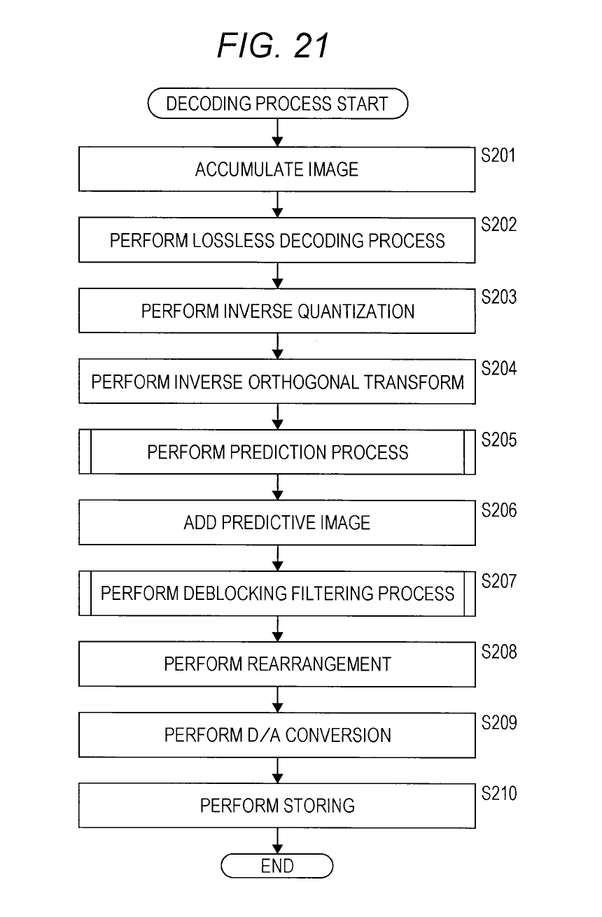

Next, the flow of each process to be performed by the above described image decoding device 200 is described. Referring first to the flowchart shown in FIG. 21, an example flow of a decoding process is described.

When the decoding process is started, the accumulation buffer 201 accumulates transmitted encoded data in step S201. In step S202, the lossless decoding unit 202 decodes the encoded data supplied from the accumulation buffer 201. Specifically, I-pictures, P-pictures, and B-pictures encoded by the lossless encoding unit 106 shown in FIG. 1 are decoded.

At this point, information, such as reference frame information, prediction mode information (an intra prediction mode or an inter prediction mode), an optimum predictor, and difference motion vector information, is also decoded.

In step S203, the inverse quantization unit 203 inversely quantizes the quantized orthogonal transform coefficient obtained by the processing in step S202.

In step S204, the inverse orthogonal transform unit 204 performs an inverse orthogonal transform on the orthogonal transform coefficient obtained through the inverse quantization in step S203, by a method compatible with the method used by the orthogonal transform unit 104 shown in FIG. 1. As a result, the difference information corresponding to the input to the orthogonal transform unit 104 (or the output from the arithmetic operation unit 103) shown in FIG. 1 is decoded.

In step S205, the intra prediction unit 211 or the motion prediction/compensation unit 212 and the motion vector decoding unit 221 perform an image prediction process in accordance with the prediction mode information supplied from the lossless decoding unit 202. Specifically, in a case where intra prediction mode information is supplied from the lossless decoding unit 202, the intra prediction unit 211 performs an intra prediction process in an intra prediction mode. In a case where inter prediction mode information is supplied from the lossless decoding unit 202, the motion prediction/compensation unit 212 performs an inter prediction process (including motion predictions and motion compensation) by using the various kinds of information about unit size obtained by the processing in step S203.

In step S206, the arithmetic operation unit 205 adds the predicted image obtained by the processing in step S205 to the difference information obtained by the processing in step S204. As a result, the original image data is decoded (or a reconstructed image is obtained).

In step S207, the deblocking filter 206, the region determination unit 222, and the boundary control unit 223 perform a deblocking filtering process. In this step, a deblocking filtering process is performed, as appropriate, on the reconstructed image obtained by the processing in step S206. This deblocking filtering process is basically the same as the deblocking filtering process described above with reference to the flowchart shown in FIG. 18, and therefore, explanation thereof is not repeated herein.

In step S208, the screen rearrangement buffer 207 rearranges the frames in the decoded image subjected to the deblocking filtering process by the processing in step S207. Specifically, in the decoded image data, the order of frames rearranged for encoding by the screen rearrangement buffer 102 of the image encoding device 100 (FIG. 1) is rearranged in the original displaying order.

In step S209, the D/A converter 208 performs a D/A conversion on the decoded image data having the frames rearranged by the processing in step S208. The decoded image data is output to a display (not shown), and the image is displayed.

In step S210, the frame memory 209 stores the decoded image data subjected to the deblocking filtering process by the processing in step S207.

[Flow of the Prediction Process]

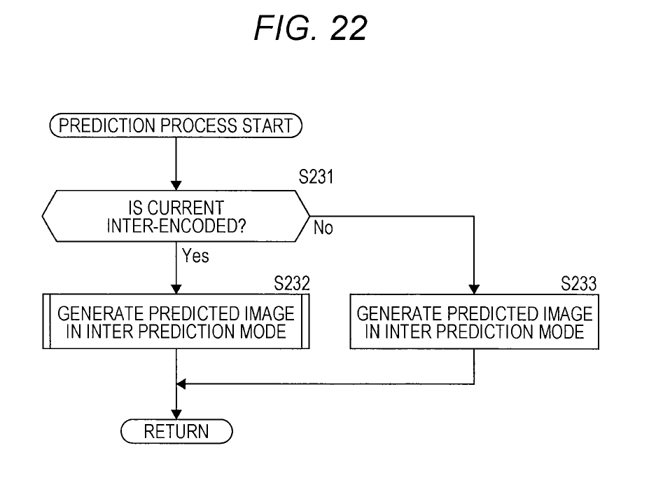

Referring now to the flowchart in FIG. 22, an example flow of the prediction process to be performed in step S205 in FIG. 21 is described.

When the prediction process is started, the lossless decoding unit 202 in step S231 determines whether the current CU (Coding Unit) as the current region is encoded in an inter prediction mode (is inter-encoded or is intra-encoded) based on the prediction mode information extracted by performing lossless decoding on a bit stream in step S202. If the current CU is determined to be inter-encoded, the lossless decoding unit 202 moves the process on to step S232.

In step S232, the motion prediction/compensation unit 212 and the motion vector decoding unit 221 perform an inter prediction process to generate a predicted image in the inter prediction mode. After generating a predicted image, the motion prediction/compensation unit 212 ends the prediction process, and the process returns to FIG. 21.

If it is determined in step S231 in FIG. 22 that the current CU is intra-encoded, the lossless decoding unit 202 moves the process on to step S233. In step S233, the intra prediction unit 211 generates a predicted image in the intra prediction mode. After generating a predicted image, the intra prediction unit 211 ends the prediction process, and the process returns to FIG. 21.

[Flow of the Inter Prediction Process]

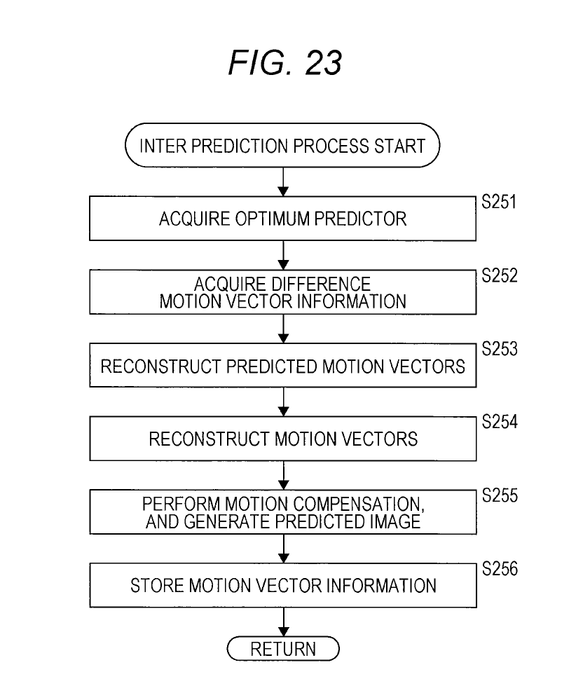

Referring now to the flowchart in FIG. 23, an example flow of the inter prediction process to be performed in step S232 in FIG. 22 is described.

When the inter prediction process is started, the optimum predictor buffer 251 in step S251 acquires and stores the optimum predictor supplied from the lossless decoding unit 202. In step S252, the difference motion vector information buffer 252 acquires and stores the difference motion vector information supplied from the lossless decoding unit 202.

In step S253, the predicted motion vector reconstruction unit 253 selects spatial adjacent motion vector information or temporal adjacent motion vector information based on the optimum predictor acquired in step S251, and reconstructs predicted motion vector information by using the selected adjacent motion vector information.

In step S254, the motion vector reconstruction unit 254 reconstructs the motion vector information about the current PU by using the difference motion vector information acquired in step S252 and the predicted motion vector information reconstructed in step S253.

In step S255, the motion prediction/compensation unit 212 performs motion compensation by using the motion vector information about the current PU reconstructed by the processing in step S254, and generates a predicted image.

In step S256, the spatial adjacent motion vector buffer 255 and the temporal adjacent motion vector buffer 256 store the motion vector information reconstructed in step S254. The stored motion vector information is to be used as adjacent motion vector information in the processing in step S253 for another PU to be processed after the current PU.

After the processing in step S256 is completed, the spatial adjacent motion vector buffer 255 and the temporal adjacent motion vector buffer 256 end the inter prediction process, and the process returns to FIG. 22.

By performing the respective processes as described above, the image decoding device 200 can reduce block distortion more accurately, and reduce degradation of the quality of decoded images.

### 2. SECOND EMBODIMENT

### Image Encoding Device

In the above description, the boundary control unit 123 (the boundary control unit 223) controls the deblocking filtering strength by adjusting the Bs value. However, the deblocking filtering strength may be controlled by any appropriate method. For example, threshold values α and β may be adjusted.

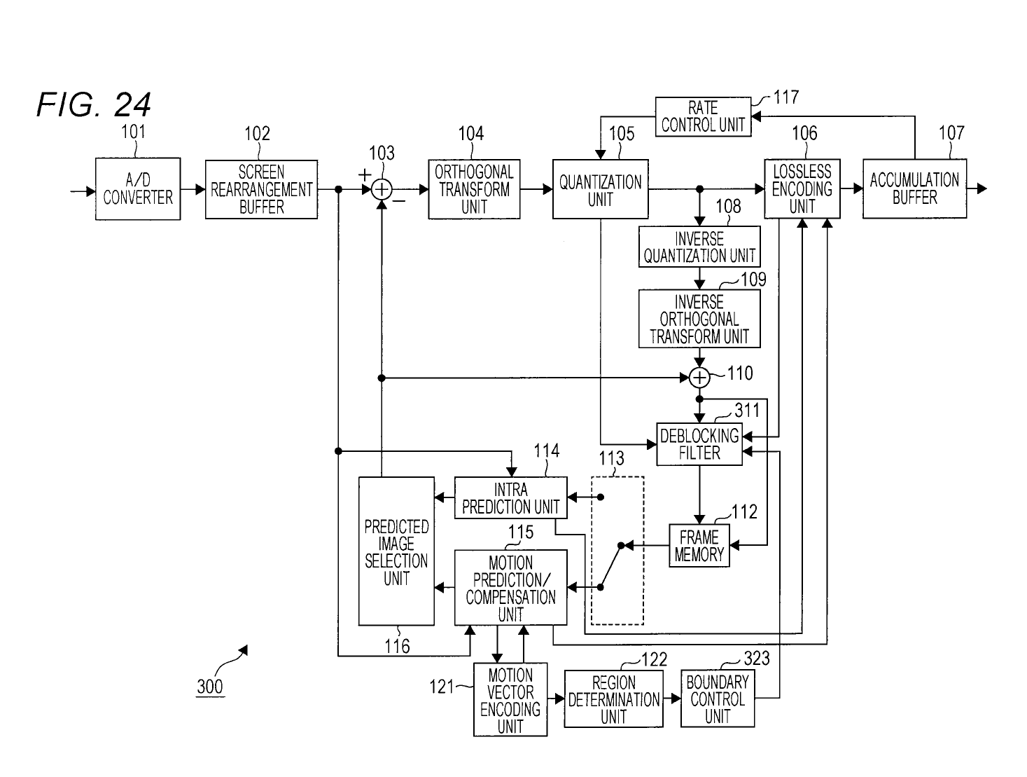

FIG. 24 is a block diagram showing a typical example structure of an image encoding device in this case. The image encoding device 300 shown in FIG. 24 is basically the same as the image encoding device 100, has substantially the same structure as the image encoding device 100, and performs substantially the same processes as the image encoding device 100. However, the image encoding device 300 includes a deblocking filter 311 in place of the deblocking filter 111 of the image encoding device 100, and a boundary control unit 323 in place of the boundary control unit 123 of the image encoding device 100.

Like the boundary control unit 123, the boundary control unit 323 controls the strength setting of the deblocking filtering process to be performed by the deblocking filter 111 in accordance with the result of the determination performed by the region determination unit 122. However, while the boundary control unit 123 controls the strength of the deblocking filtering process by adjusting the Bs value, the boundary control unit 323 controls the strength of the deblocking filtering process by adjusting the threshold values α and β.

Like the deblocking filter 111, the deblocking filter 311 performs, as appropriate, a deblocking process on a reconstructed image supplied from the arithmetic operation unit 110. However, while the deblocking filter 111 under the control of the boundary control unit 123 controls the strength of the deblocking filtering process by adjusting the Bs value, the deblocking filter 311 controls the strength of the deblocking filtering process by adjusting the threshold values α and β.

[Motion Vector Encoding Unit, Region Determination Unit, Boundary Control Unit, and Deblocking Filter]

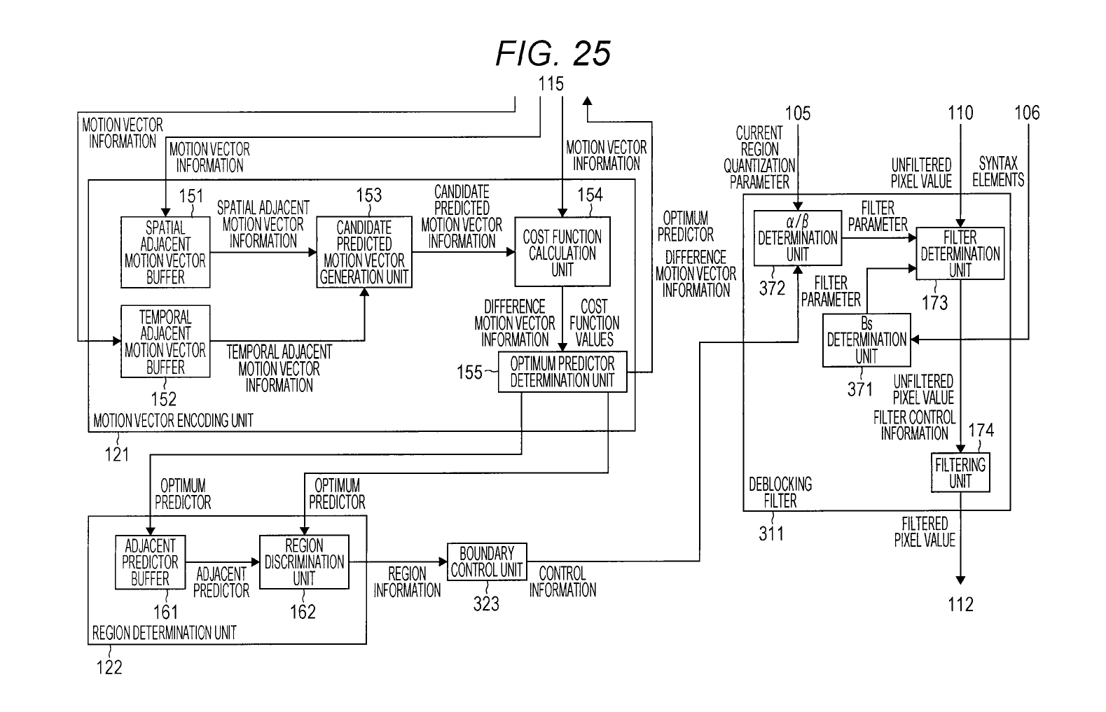

FIG. 25 is a block diagram showing typical example structures of the motion vector encoding unit 121, the region determination unit 122, and the deblocking filter 311.

As shown in FIG. 25, the deblocking filter 311 has substantially the same structure as the deblocking filter 111, but includes a Bs determination unit 371 in place of the Bs determination unit 171 of the deblocking filter 111, and an α/β determination unit 372 in place of the α/β determination unit 172 of the deblocking filter 111.

As in the case illustrated in FIG. 14, the region discrimination unit 162 of the region determination unit 122 acquires an adjacent predictor from the adjacent predictor buffer 161, and determines whether the adjacent predictor is the same as the optimum predictor of the current PU. The region discrimination unit 162 supplies the determination result as region information to the boundary control unit 323.

Acquiring the region information including the information indicating the feature related to block distortion in the current PU from the region discrimination unit 162, the boundary control unit 323 controls the filtering strength of the deblocking filter 111 in accordance with the feature, like the boundary control unit 123. More specifically, the boundary control unit 323 performs control to set a higher deblocking filtering strength on a region where block distortion is likely to be observed, or on a PU that has been determined, by the region discrimination unit 162, to have a different predictor from the predictor applied to the adjacent PU.

However, the boundary control unit 323 differs from the boundary control unit 123, in controlling the deblocking filtering strength by having the threshold values α and β corrected. To do so, any appropriate adjustment method may be used. The threshold values α and β are determined based on the quantization parameter QP. Therefore, the boundary control unit 323 has the quantization parameter QP corrected by adding a predetermined correction quantization parameter ΔQP thereto, for example.

As the correction quantization parameter ΔQP is added, the value of the quantization parameter QP is corrected, so that the threshold values α and β are corrected, and the deblocking filtering strength is increased. That is, the correction quantization parameter ΔQP is set to such a value that the deblocking filtering strength is increased when ΔQP is added to the quantization parameter QP.

As for a PU determined to have the same predictor as the adjacent PU, the boundary control unit 323 does not correct the value of the quantization parameter QP (or maintains the value supplied from the quantization unit 105).

The boundary control unit 323 realizes adjustment of the deblocking filtering strength by supplying control information indicating an instruction to correct the threshold values α and β to the α/β determination unit 372 of the deblocking filter 111.

Accordingly, the Bs determination unit 371 of the deblocking filter 311 is not under the control of the boundary control unit 323, and determines the Bs value based on the syntax elements supplied from the lossless encoding unit 106. The Bs determination unit 371 supplies the determined Bs value as a filter parameter to the filter determination unit 173.

Meanwhile, in accordance with the control information supplied from the boundary control unit 323, the α/β determination unit 372 corrects the value of the quantization parameter of the current PU (the current region quantization parameter) supplied from the quantization unit 105 by adding the predetermined correction quantization parameter ΔQP thereto, and determines the values of α and β by using the corrected value. As described above, through the correction of the quantization parameter, the values of α and β are adjusted so as to increase the deblocking filtering strength.

The α/β determination unit 372 supplies the determined α and β as filter parameters to the filter determination unit 173.

Using the filter parameters supplied from the Bs determination unit 371 and the α/β determination unit 372, the filter determination unit 173 performs processing in the same manner as in the case illustrated in FIG. 14. The filtering unit 174 also performs processing in the same manner as in the case illustrated in FIG. 14.

As described above, the region determination unit 122 compares the predictor of the current PU with the predictor of an adjacent PU, to detect a PU in which block distortion is likely to be observed. The boundary control unit 323 then performs control to set a higher deblocking filtering strength for the PU in which block distortion is likely to be observed. Under the control thereof, the α/β determination unit 372 corrects the values of α and β. As a result, the filtering unit 174 can perform a deblocking filtering process with an increased strength for the PU in which block distortion is likely to be observed. That is, the deblocking filter 311 can reduce block distortion more accurately. Accordingly, the image encoding device 300 can reduce degradation of the quality of decoded images.

In performing the control to increase the deblocking filtering strength, the boundary control unit 323 may not correct the quantization parameter QP, but may correct the values of α and β calculated based on the quantization parameter QP supplied from the quantization unit 105.

[Flow of the Deblocking Filtering Process]

The encoding process in this case is performed substantially in the same manner as the encoding process performed by the image encoding device 100 as described above with reference to the flowchart in FIG. 16, and therefore, explanation thereof is not repeated herein.

The inter motion prediction process in this case is performed substantially in the same manner as the inter motion prediction process performed by the image encoding device 100 as described above with reference to the flowchart in FIG. 17, and therefore, explanation thereof is not repeated herein.

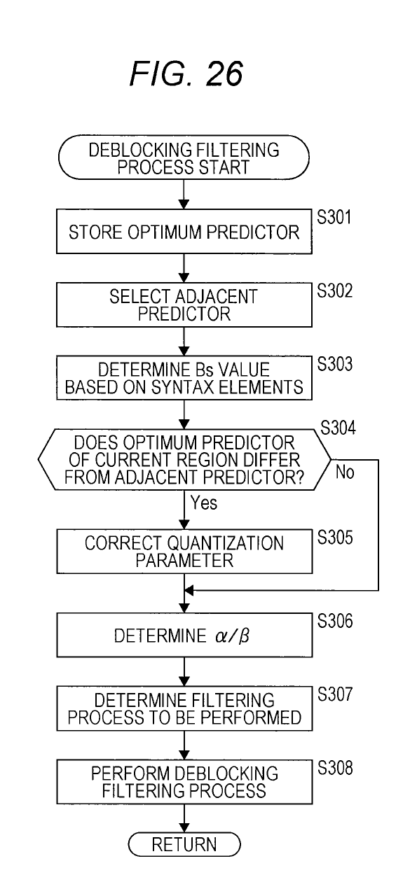

Referring now to the flowchart shown in FIG. 26, an example flow of the deblocking filtering process to be performed in this case is described. This process is equivalent to the deblocking filtering process described above with reference to the flowchart in FIG. 18.

The processing in steps S301 and S302 is performed in the same manner as the processing in steps S151 and S152 in FIG. 18.

In step S303, the Bs determination unit 371 determines the Bs value based on syntax elements.

In step S304, the region discrimination unit 162 determines whether the optimum predictor of the current PU differs from the adjacent predictor.

When determining that the two predictors differ from each other, the region discrimination unit 162 moves the process on to step S305. For example, in a case where the region discrimination unit 162 determines that the optimum predictor of the current PU is a Spatial Predictor and the adjacent predictor is a Temporal Predictor (or a Spatio-Temporal Predictor), or where the region discrimination unit 162 determines that the optimum predictor of the current PU is a Temporal Predictor (or a Spatio-Temporal Predictor) and the adjacent predictor is a Spatial Predictor, the region discrimination unit 162 moves the process on to step S154.

In step S305, the boundary control unit 123 has the value of the quantization parameter QP corrected so as to increase the filtering strength. Under the control thereof, the α/β determination unit 372 corrects the quantization parameter QP. After correcting the quantization parameter, the α/β determination unit 372 moves the process on to step S306.

In a case where the optimum predictor of the current PU and the adjacent predictor are determined to be the same in step S304, the region discrimination unit 162 skips the processing in step S305, and moves the process on to step S306.

For example, in a case where the region discrimination unit 162 determines that the optimum predictor of the current PU and the adjacent predictor are Spatial Predictors, or where the region discrimination unit 162 determines that the optimum predictor of the current PU and the adjacent predictor are Temporal Predictors (or Spatio-Temporal Predictors), the region discrimination unit 162 moves the process on to step S306.

In step S306, the α/β determination unit 372 determines α and β based on the (corrected or uncorrected) quantization parameter and the like.

The processing in steps S307 and S308 is performed in the same manner as the processing in steps S157 and S158 in FIG. 18.

When the processing in step S308 is completed, the filtering unit 174 ends the deblocking filtering process.

By performing the respective processes as described above, the image encoding device 300 can reduce block distortion more accurately, and reduce degradation of the quality of decoded images.

[Image Decoding Device]

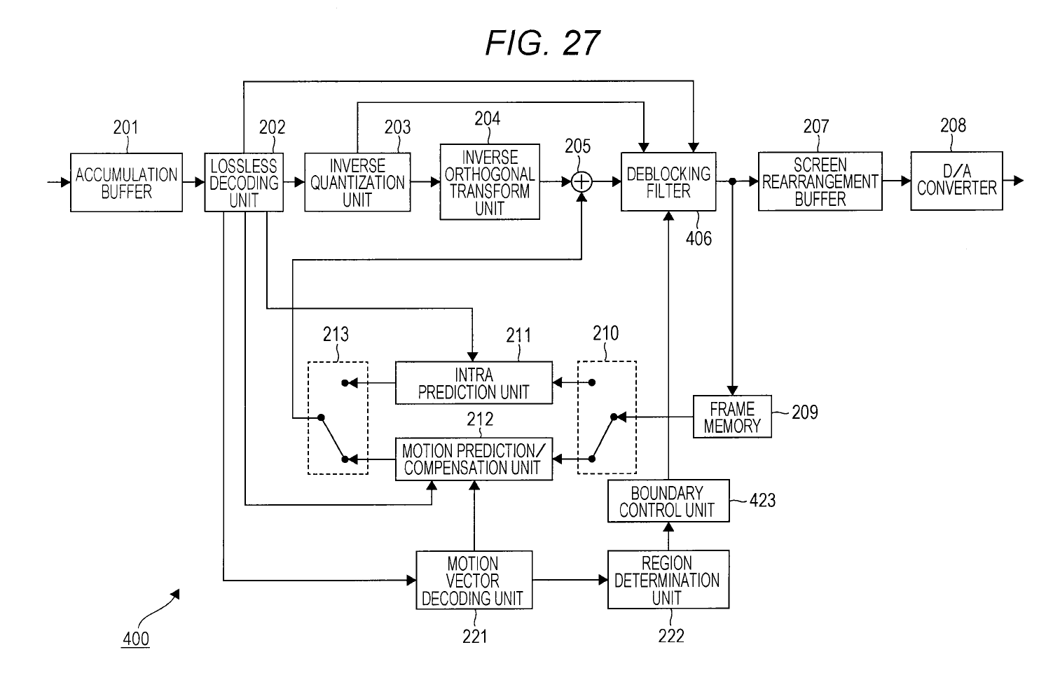

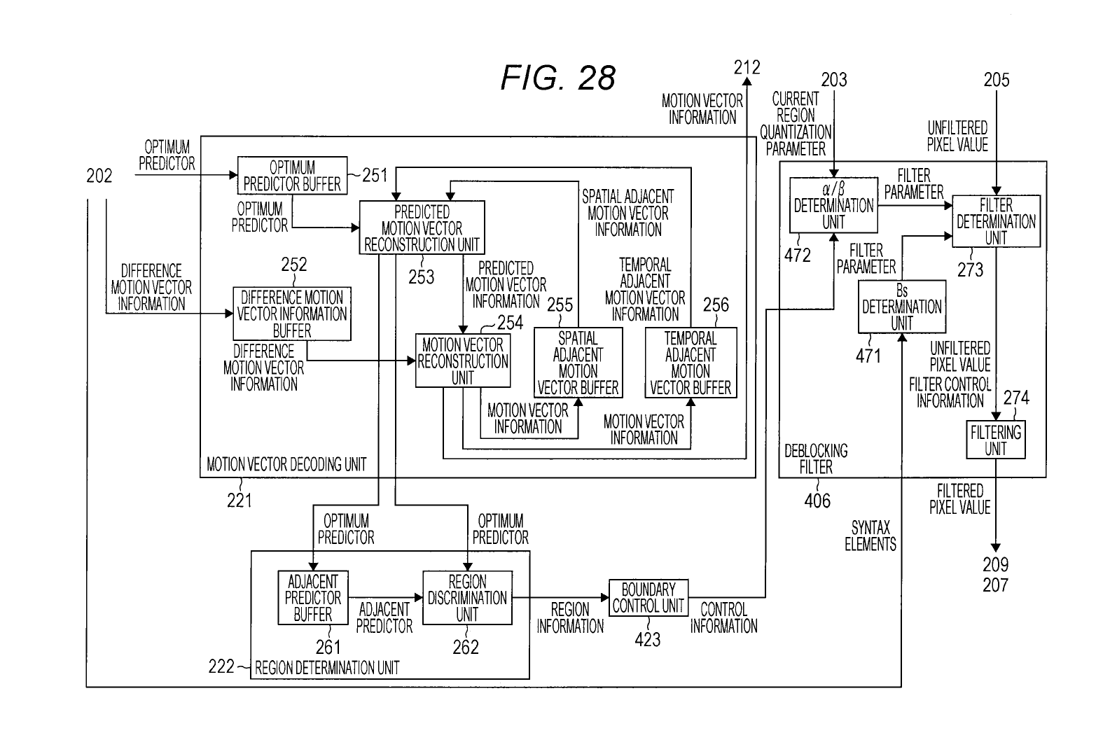

FIG. 27 is a block diagram showing a typical example structure of an image decoding device that is an image processing device to which the present technique is applied. The image decoding device 400 shown in FIG. 27 is compatible with the above described image encoding device 300, and generates a decoded image by correctly decoding a bit stream (encoded data) generated by the image encoding device 300 encoding image data.

Specifically, the image decoding device 400 shown in FIG. 27 is basically the same as the image decoding device 200, has substantially the same structure as the image decoding device 200, and performs substantially the same processes as the image decoding device 200. However, the image decoding device 400 includes a deblocking filter 406 in place of the deblocking filter 206 of the image decoding device 200, and a boundary control unit 423 in place of the boundary control unit 223 of the image decoding device 200.

Like the boundary control unit 223, the boundary control unit 423 controls the strength setting of the deblocking filtering process to be performed by the deblocking filter 206 in accordance with the result of the determination performed by the region discrimination unit 262. However, while the boundary control unit 223 controls the strength of the deblocking filtering process by adjusting the Bs value, the boundary control unit 423 controls the strength of the deblocking filtering process by adjusting the threshold values α and β.

Like the deblocking filter 206, the deblocking filter 406 performs, as appropriate, a deblocking process on a reconstructed image supplied from the arithmetic operation unit 205. However, while the deblocking filter 206 under the control of the boundary control unit 223 controls the strength of the deblocking filtering process by adjusting the Bs value, the deblocking filter 406 controls the strength of the deblocking filtering process by adjusting the threshold values α and β.

[Motion Vector Decoding Unit, Region Determination Unit, Boundary Control Unit, and Deblocking Filter]

FIG. 28 is a block diagram showing typical example structures of the motion vector decoding unit 221, the region determination unit 222, and the deblocking filter 406.

As shown in FIG. 28, the deblocking filter 406 has substantially the same structure as the deblocking filter 206, but includes a Bs determination unit 471 in place of the Bs determination unit 271 of the deblocking filter 206, and an α/β determination unit 472 in place of the α/β determination unit 272 of the deblocking filter 206.

As in the case illustrated in FIG. 20, the region discrimination unit 262 of the region determination unit 222 acquires an adjacent predictor from the adjacent predictor buffer 261, and determines whether the adjacent predictor is the same as the optimum predictor of the current PU. The region discrimination unit 262 supplies the determination result as region information to the boundary control unit 423.

Acquiring the region information including the information indicating the feature related to block distortion in the current PU from the region discrimination unit 262, the boundary control unit 423 controls the filtering strength of the deblocking filter 206 in accordance with the feature, like the boundary control unit 223. More specifically, the boundary control unit 423 performs control to set a higher deblocking filtering strength on a region where block distortion is likely to be observed, or on a PU that has been determined, by the region discrimination unit 262, to have a different predictor from the predictor applied to the adjacent PU.

However, the boundary control unit 423 differs from the boundary control unit 223, in controlling the deblocking filtering strength by having the threshold values α and β corrected. To do so, any appropriate adjustment method may be used. For example, the boundary control unit 423 has the quantization parameter QP corrected by adding a predetermined correction quantization parameter ΔQP thereto, for example.

As the correction quantization parameter ΔQP is added, the value of the quantization parameter QP is corrected, so that the threshold values α and β are corrected, and the deblocking filtering strength is increased. That is, the correction quantization parameter ΔQP is set to such a value that the deblocking filtering strength is increased when ΔQP is added to the quantization parameter QP.

As for a PU determined to have the same predictor as the adjacent PU, the boundary control unit 423 does not correct the value of the quantization parameter QP (or maintains the value supplied from the inverse quantization unit 203).

The boundary control unit 423 realizes adjustment of the deblocking filtering strength by supplying control information indicating an instruction to correct the threshold values α and β to the α/β determination unit 472 of the deblocking filter 406.

Accordingly, the Bs determination unit 471 of the deblocking filter 406 is not under the control of the boundary control unit 423, and determines the Bs value based on the syntax elements supplied from the lossless decoding unit 202. The Bs determination unit 471 supplies the determined Bs value as a filter parameter to the filter determination unit 273.

Meanwhile, in accordance with the control information supplied from the boundary control unit 423, the α/β determination unit 472 corrects the value of the quantization parameter of the current PU (the current region quantization parameter) supplied from the inverse quantization unit 203 by adding the predetermined correction quantization parameter ΔQP thereto, and determines the values of α and β by using the corrected value. As described above, through the correction of the quantization parameter, the values of α and β are adjusted so as to increase the deblocking filtering strength.

The α/β determination unit 472 supplies the determined α and β as filter parameters to the filter determination unit 273.

Using the filter parameters supplied from the Bs determination unit 471 and the α/β determination unit 472, the filter determination unit 273 performs processing in the same manner as in the case illustrated in FIG. 20. The filtering unit 274 also performs processing in the same manner as in the case illustrated in FIG. 20.

As described above, the region determination unit 222 compares the predictor of the current PU with the predictor of an adjacent PU, to detect a PU in which block distortion is likely to be observed. The boundary control unit 423 then performs control to set a higher deblocking filtering strength for the PU in which block distortion is likely to be observed. Under the control thereof, the α/β determination unit 472 corrects the values of α and β. As a result, the filtering unit 274 can perform a deblocking filtering process with an increased strength for the PU in which block distortion is likely to be observed. That is, the deblocking filter 406 can reduce block distortion more accurately. Accordingly, the image decoding device 400 can reduce degradation of the quality of decoded images.

In performing the control to increase the deblocking filtering strength, the boundary control unit 423 may not correct the quantization parameter QP, but may correct the values of α and β calculated based on the quantization parameter QP supplied from the inverse quantization unit 203.

The deblocking filtering strength may be increased by a method other than the above described example methods. For example, the boundary control unit may perform control to adjust the Bs value and the threshold values α and β (or the quantization parameter), or to adjust more than one parameter.

In the above description, a check, using predictors, is made to determine whether block distortion is likely to be observed in the current PU. However, the check may be made by any other method, as long as the strength of the deblocking filtering process for regions where block distortion is likely to be observed can be increased. That is, a check of any kind may be made to determine whether block distortion is likely to be observed.

### 3. THIRD EMBODIMENT

### Computer

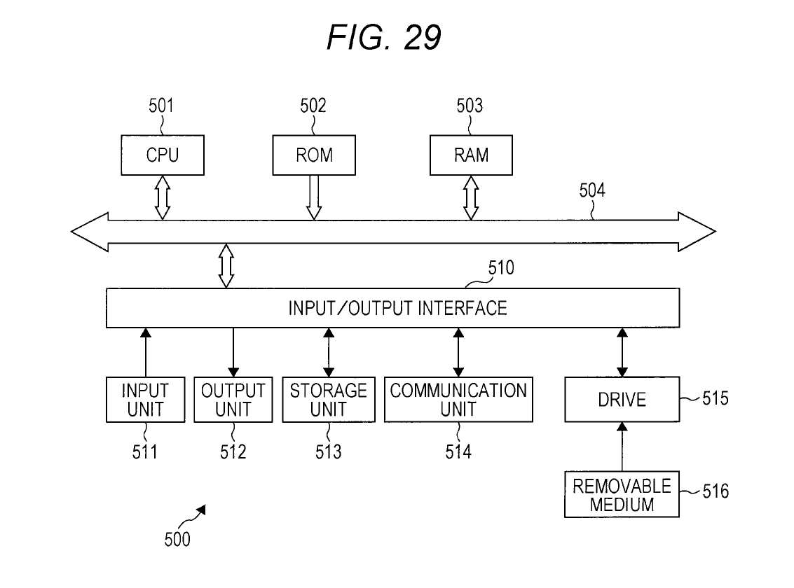

The above described series of processes can be performed by hardware or can be performed by software. In this case, the processes may be realized by a computer as shown in FIG. 29, for example.

In FIG. 29, the CPU (Central Processing Unit) 501 of a computer 500 performs various kinds of processes in accordance with a program stored in a ROM (Read Only Memory) 502, or a program loaded from a storage unit 513 into a RAM (Random Access Memory) 503. The RAM 503 also stores data necessary for the CPU 501 to perform various processes and the like as necessary.

The CPU 501, the ROM 502, and the RAM 503 are connected to one another via a bus 504. An input/output interface 510 is also connected to the bus 504.

The following components are also connected to the input/output interface 510: an input unit 511 formed with a keyboard, a mouse, a touch panel, an input terminal, or the like; an output unit 512 formed with output devices or output terminals including a display such as a CRT (Cathode Ray Tube), an LCD (Liquid Crystal Display), or an OELD (Organic ElectroLuminescence Display), and a speaker; a storage unit 513 formed with a storage medium such as a hard disk or a flash memory, and a control unit or the like that controls inputs and outputs of the storage medium; and a communication unit 514 formed with a wired or wireless communication device such as a modem, a LAN interface, a USB (Universal Serial Bus), or Bluetooth (a registered trade name). The communication unit 514 performs communications with other communication devices via networks including the Internet, for example.

A drive 515 is also connected to the input/output interface 510, if necessary. A removable medium 521 such as a magnetic disk, an optical disk, a magnetooptical disk, or a semiconductor memory is mounted on the drive 515, as appropriate. Under the control of the CPU 501, for example, the drive 515 reads computer programs, data, and the like from the removable medium 521 mounted thereon. The read data and the read computer programs are supplied to the RAM 503, for example. The computer programs that have been read from the removable medium 521 are installed into the storage unit 513 as necessary.

When the above described series of processes are performed by software, the programs constituting the software are installed from a network or a recording medium.

As shown in FIG. 29, examples of the recording medium include the removable medium 521 that is distributed for delivering programs to users separately from the device, such as a magnetic disk (including a flexible disk), an optical disk (including a CD-ROM (compact disc-read only memory) or a DVD (digital versatile disc)), a magnetooptical disk (including an MD (mini disc)), and a semiconductor memory, which has programs recorded thereon, and alternatively, the ROM 502 having programs recorded therein and a hard disk included in the storage unit 513, which are incorporated beforehand into the device prior to delivery to users.

The programs to be executed by the computer may be programs for performing processes in chronological order in accordance with the sequence described in this specification, or may be programs for performing processes in parallel or performing a process when necessary, such as when there is a call.

In this specification, steps describing programs to be recorded in a recording medium include processes to be performed in parallel or independently of one another if not necessarily in chronological order, as well as processes to be performed in chronological order in accordance with the sequence described herein.

In this specification, a “system” means an entire apparatus formed with two or more devices (apparatuses).

Also, in the above described examples, any structure described as one device (or one processing unit) may be divided into two or more devices (or processing units). Conversely, any structure described as two or more devices (or processing units) may be combined to form one device (or one processing unit). Also, it is of course possible to add a structure other than the above described ones to the structure of any of the devices (or any of the processing units). Further, as long as the structure and function of the entire system remain the same, part of the structure of a device (or a processing unit) may be incorporated into another device (or another processing unit). That is, embodiments of the present technique are not limited to the above described embodiments, and various modifications may be made to them without departing from the scope of the technique.

The image encoding device 100 (FIG. 1), the image decoding device 200 (FIG. 19), the image encoding device 300 (FIG. 24), and the image decoding device 400 (FIG. 27) according to the above described embodiments can be applied to various electronic apparatuses including: transmitters and receivers for satellite broadcasting, cable broadcasting such as cable television, deliveries via the Internet, deliveries to terminals by cellular communications, and the like; recording apparatuses that record images on media such as optical disks, magnetic disks, or flash memories; or reproducing apparatuses that reproduce images from those storage media. Four examples of applications will be described below.

### 4. FOURTH EMBODIMENT

### Television Apparatus

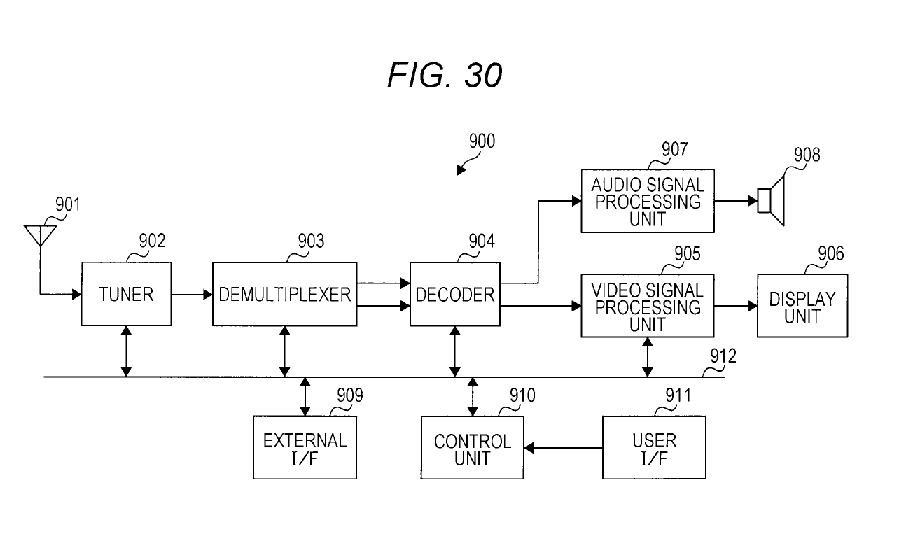

FIG. 30 schematically shows an example structure of a television apparatus to which the above described embodiments are applied. The television apparatus 900 includes an antenna 901, a tuner 902, a demultiplexer 903, a decoder 904, a video signal processing unit 905, a display unit 906, an audio signal processing unit 907, a speaker 908, an external interface 909, a control unit 910, a user interface 911, and a bus 912.

The tuner 902 extracts a signal of a desired channel from broadcast signals received via the antenna 901, and demodulates the extracted signal. The tuner 902 outputs the encoded bit stream obtained by the demodulation to the demultiplexer 903. That is, the tuner 902 serves as a transmission unit in the television apparatus 900 that receives an encoded stream of encoded images.

The demultiplexer 903 separates the video stream and the audio stream of a show to be viewed from the encoded bit stream, and outputs the respective separated streams to the decoder 904. The demultiplexer 903 also extracts auxiliary data such as an EPG (Electronic Program Guide) from the encoded bit stream, and supplies the extracted data to the control unit 910. In a case where the encoded bit stream has been scrambled, the demultiplexer 903 may perform descrambling.

The decoder 904 decodes the video stream and the audio stream input from the demultiplexer 903. The decoder 904 then outputs video data generated by the decoding to the video signal processing unit 905. The decoder 904 also outputs audio data generated by the decoding to the audio signal processing unit 907.

The video signal processing unit 905 reproduces the video data input from the decoder 904, and causes the display unit 906 to display the video image. Also, the video signal processing unit 905 may cause the display unit 906 to display an application screen supplied via a network. Also, the video signal processing unit 905 may perform additional processing such as denoising on the video data in accordance with the settings. Further, the video signal processing unit 905 may generate an image of a GUI (Graphical User Interface) such as a menu and buttons or a cursor, and superimpose the generated image on an output image.

The display unit 906 is driven by a drive signal supplied from the video signal processing unit 905, and displays a video image or an image on the video screen of a display device (such as a liquid crystal display, a plasma display, or an OELD (Organic ElectroLuminescence Display)).

The audio signal processing unit 907 performs a reproduction process such as a D/A conversion and amplification on the audio data input from the decoder 904, and outputs sound from the speaker 908. Also, the audio signal processing unit 907 may perform additional processing such as denoising on the audio data.

The external interface 909 is an interface for connecting the television apparatus 900 to an external device or a network. For example, a video stream or an audio stream received via the external interface 909 may be decoded by the decoder 904. That is, the external interface 909 also serves as a transmission unit in the television apparatus 900 that receives an encoded stream of encoded images.

The control unit 910 includes a processor such as a CPU, and a memory such as a RAM or a ROM. The memory stores the program to be executed by the CPU, program data, EPG data, data acquired via networks, and the like. The program stored in the memory is read by the CPU at the time of activation of the television apparatus 900, for example, and is then executed. By executing the program, the CPU controls operations of the television apparatus 900 in accordance with an operating signal input from the user interface 911, for example.

The user interface 911 is connected to the control unit 910. The user interface 911 includes buttons and switches for the user to operate the television apparatus 900, and a reception unit for remote control signals, for example. The user interface 911 generates an operating signal by detecting an operation by the user via those components, and outputs the generated operating signal to the control unit 910.

The bus 912 connects the tuner 902, the demultiplexer 903, the decoder 904, the video signal processing unit 905, the audio signal processing unit 907, the external interface 909, and the control unit 910 to one another.

In the television apparatus 900 having the above described structure, the decoder 904 has the functions of the image decoding device 200 (FIG. 19) according to an embodiment described above. Accordingly, the decoder 904 can detect a region where block distortion is likely to be observed and a different predictor from that of the adjacent region is selected, and increase the deblocking filtering strength for the region. By doing so, the decoder 904 can reduce block distortion more accurately.

Accordingly, the television apparatus 900 can reduce degradation of the quality of decoded images.

### 5. FIFTH EMBODIMENT

### Portable Telephone Device

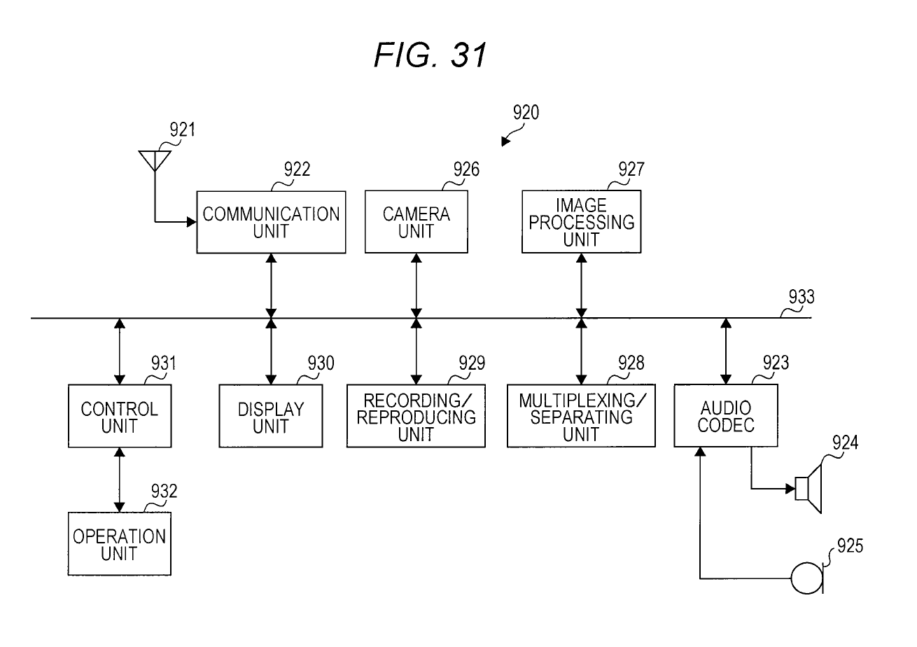

FIG. 31 schematically shows an example structure of a portable telephone device to which the above described embodiments are applied. The portable telephone device 920 includes an antenna 921, a communication unit 922, an audio codec 923, a speaker 924, a microphone 925, a camera unit 926, an image processing unit 927, a multiplexing/separating unit 928, a recording/reproducing unit 929, a display unit 930, a control unit 931, an operation unit 932, and a bus 933.

The antenna 921 is connected to the communication unit 922. The speaker 924 and the microphone 925 are connected to the audio codec 923. The operation unit 932 is connected to the control unit 931. The bus 933 connects the communication unit 922, the audio codec 923, the camera unit 926, the image processing unit 927, the multiplexing/separating unit 928, the recording/reproducing unit 929, the display unit 930, and the control unit 931 to one another.

The portable telephone device 920 performs operations such as transmission and reception of audio signals, transmission and reception of electronic mail or image data, imaging operations, and data recording in various operation modes including an audio communication mode, a data communication mode, an imaging mode, and a video phone mode.

In the audio communication mode, an analog audio signal generated by the microphone 925 is supplied to the audio codec 923. The audio codec 923 converts the analog audio signal to audio data, and performs compression and an A/D conversion on the converted audio data. The audio codec 923 outputs the compressed audio data to the communication unit 922. The communication unit 922 encodes and modulates the audio data, to generate a transmission signal. The communication unit 922 transmits the generated transmission signal to a base station (not shown) via the antenna 921. The communication unit 922 also performs amplification and a frequency conversion on a radio signal received via the antenna 921, and obtains a reception signal. The communication unit 922 generates audio data by demodulating and decoding the reception signal, and outputs the generated audio data to the audio codec 923. The audio codec 923 performs decompression and a D/A conversion on the audio data, to generate an analog audio signal. The audio codec 923 then outputs the generated audio signal to the speaker 924 to output sound.

In the data communication mode, the control unit 931 generates text data constituting an electronic mail in accordance with an operation by the user via the operation unit 932. The control unit 931 causes the display unit 930 to display the text. The control unit 931 also generates electronic mail data in accordance with a transmission instruction from the user via the operation unit 932, and outputs the generated electronic mail data to the communication unit 922. The communication unit 922 encodes and modulates the electronic mail data, to generate a transmission signal. The communication unit 922 transmits the generated transmission signal to a base station (not shown) via the antenna 921. The communication unit 922 also performs amplification and a frequency conversion on a radio signal received via the antenna 921, and obtains a reception signal. The communication unit 922 then restores the electronic mail data by demodulating and decoding the reception signal, and outputs the restored electronic mail data to the control unit 931. The control unit 931 causes the display unit 930 to display the contents of the electronic mail, and stores the electronic mail data into the storage medium in the recording/reproducing unit 929.

The recording/reproducing unit 929 includes a readable/rewritable storage medium. For example, the storage medium may be an internal storage medium such as a RAM or a flash memory, or may be a storage medium of an externally mounted type such as a hard disk, a magnetic disk, a magnetooptical disk, an optical disk, a USB memory, or a memory card.

In the imaging mode, the camera unit 926 generates image data by capturing an image of an object, and outputs the generated image data to the image processing unit 927. The image processing unit 927 encodes the image data input from the camera unit 926, and stores the encoded stream into the storage medium in the recording/reproducing unit 929.

In the video phone mode, the multiplexing/separating unit 928 multiplexes a video stream encoded by the image processing unit 927 and an audio stream input from the audio codec 923, and outputs the multiplexed stream to the communication unit 922. The communication unit 922 encodes and modulates the stream, to generate a transmission signal. The communication unit 922 transmits the generated transmission signal to a base station (not shown) via the antenna 921. The communication unit 922 also performs amplification and a frequency conversion on a radio signal received via the antenna 921, and obtains a reception signal. The transmission signal and the reception signal may include an encoded bit stream. The communication unit 922 restores a stream by demodulating and decoding the reception signal, and outputs the restored stream to the multiplexing/separating unit 928. The multiplexing/separating unit 928 separates the video stream and the audio stream from the input stream, and outputs the video stream to the image processing unit 927 and the audio stream to the audio codec 923. The image processing unit 927 decodes the video stream, to generate video data. The video data is supplied to the display unit 930, and a series of images are displayed by the display unit 930. The audio codec 923 performs decompression and a D/A conversion on the audio stream, to generate an analog audio signal. The audio codec 923 then outputs the generated audio signal to the speaker 924 to output sound.

In the portable telephone device 920 having the above described structure, the image processing unit 927 has the functions of the image encoding device 100 (FIG. 1), the functions of the image decoding device 200 (FIG. 19), the functions of the image encoding device 300 (FIG. 24), and the functions of the image decoding device 400 (FIG. 27) according to the above described embodiments. Accordingly, in an image to be encoded and decoded in the portable telephone device 920, the image processing unit 927 can detect a region where block distortion is likely to be observed and a different predictor from that of the adjacent region is selected, and increase the deblocking filtering strength for the region. By doing so, the portable telephone device 920 can reduce block distortion more accurately. Accordingly, the television apparatus 900 can reduce degradation of the quality of decoded images.

Although the portable telephone device 920 has been described above, an image encoding device and an image decoding device to which the present technique is applied can also be used in any device in the same manner as in the case with the portable telephone device 920, as long as the device has the same image capturing function and the same communication function as the portable telephone 920. Such a device may be a PDA (Personal Digital Assistant), a smartphone, an UMPC (Ultra Mobile Personal Computer), a netbook, or a notebook personal computer, for example.

### 6. SIXTH EMBODIMENT

### Recording/Reproducing Apparatus

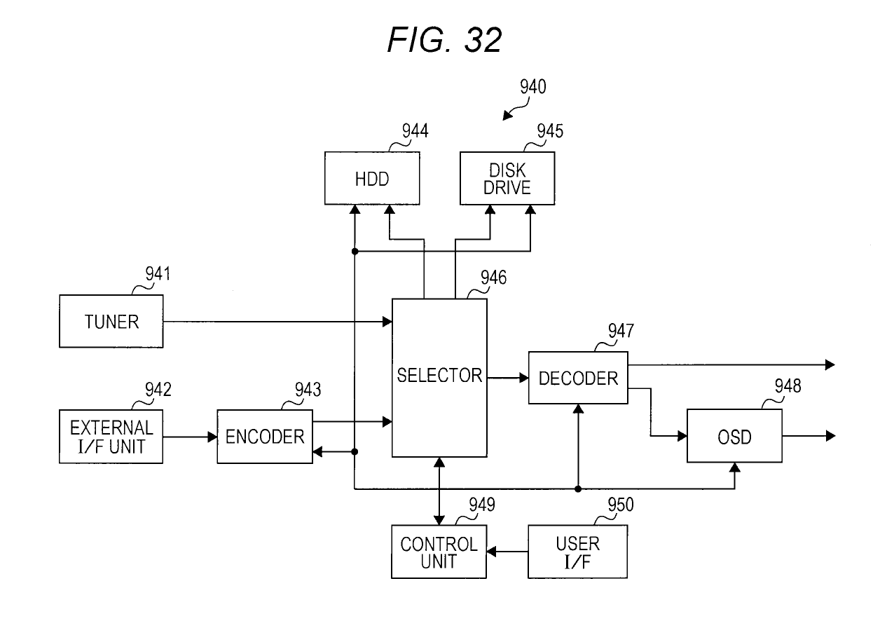

FIG. 32 schematically shows an example structure of a recording/reproducing apparatus to which the above described embodiments are applied. A recording/reproducing apparatus 940 encodes audio data and video data of a received broadcast show, for example, and records the audio data and the video data on a recording medium. The recording/reproducing apparatus 940 may encode audio data and video data acquired from another apparatus, for example, and record the audio data and the video data on the recording medium. The recording/reproducing apparatus 940 also reproduces data recorded on the recording medium through a monitor and a speaker in accordance with an instruction from the user, for example. In doing so, the recording/reproducing apparatus 940 decodes audio data and video data.

The recording/reproducing apparatus 940 includes a tuner 941, an external interface 942, an encoder 943, an HDD (Hard Disk Drive) 944, a disk drive 945, a selector 946, a decoder 947, an OSD (On-Screen Display) 948, a control unit 949, and a user interface 950.

The tuner 941 extracts a signal of a desired channel from broadcast signals received via an antenna (not shown), and demodulates the extracted signal. The tuner 941 outputs the encoded bit stream obtained by the demodulation to the selector 946. That is, the tuner 941 serves as a transmission unit in the recording/reproducing apparatus 940.

The external interface 942 is an interface for connecting the recording/reproducing apparatus 940 to an external device or a network. The external interface 942 may be an IEEE1394 interface, a network interface, a USB interface, or a flash memory interface, for example. Video data and audio data received via the external interface 942 are input to the encoder 943, for example. That is, the external interface 942 serves as a transmission unit in the recording/reproducing apparatus 940.

In a case where video data and audio data input from the external interface 942 have not been encoded, the encoder 943 encodes the video data and the audio data. The encoder 943 then outputs an encoded bit stream to the selector 946.

The HDD 944 records an encoded bit stream formed with compressed content data such as video images and sound, various programs, and other data on an internal hard disk. At the time of reproduction of video images and sound, the HDD 944 reads those data from the hard disk.

The disk drive 945 records data on and reads data from a recording medium mounted thereon. The recording medium mounted on the disk drive 945 may be a DVD disk (such as a DVD-Video, a DVD-RAM, a DVD-R, a DVD-RW, a DVD+R, or a DVD+RW) or a Blu-ray (a registered trade name) disk, for example.

At the time of recording of video images and sound, the selector 946 selects an encoded bit stream input from the tuner 941 or the encoder 943, and outputs the selected encoded bit stream to the HDD 944 or the disk drive 945. At the time of reproduction of video images and sound, the selector 946 also outputs an encoded bit stream input from the HDD 944 or the disk drive 945, to the decoder 947.

The decoder 947 decodes the encoded bit stream, and generates video data and audio data. The decoder 947 outputs the generated video data to the OSD 948. The decoder 904 also outputs the generated audio data to an external speaker.

The OSD 948 reproduces the video data input from the decoder 947, and displays video images. The OSD 948 may superimpose an image of a GUI such as a menu and buttons or a cursor on the video images to be displayed.

The control unit 949 includes a processor such as a CPU, and a memory such as a RAM or a ROM. The memory stores the program to be executed by the CPU, program data, and the like. The program stored in the memory is read by the CPU at the time of activation of the recording/reproducing apparatus 940, for example, and is then executed. By executing the program, the CPU controls operations of the recording/reproducing apparatus 940 in accordance with an operating signal input from the user interface 950, for example.

The user interface 950 is connected to the control unit 949. The user interface 950 includes buttons and switches for the user to operate the recording/reproducing apparatus 940, and a reception unit for remote control signals, for example. The user interface 950 generates an operating signal by detecting an operation by the user via those components, and outputs the generated operating signal to the control unit 949.

In the recording/reproducing apparatus 940 having the above described structure, the encoder 943 has the functions of the image encoding device 100 (FIG. 1) and the image encoding device 300 (FIG. 24) according to the above described embodiments. Also, the decoder 947 has the functions of the image decoding device 200 (FIG. 19) and the image decoding device 400 (FIG. 27) according to the above described embodiments. Accordingly, in an image to be encoded and decoded in the recording/reproducing apparatus 940, the encoder 943 and the decoder 947 can detect a region where block distortion is likely to be observed and a different predictor from that of the adjacent region is selected, and increase the deblocking filtering strength for the region. By doing so, the encoder 943 and the decoder 947 can reduce block distortion more accurately. Accordingly, the recording/reproducing apparatus 940 can reduce degradation of the quality of decoded images.

### 7. SEVENTH EMBODIMENT

### Imaging Apparatus

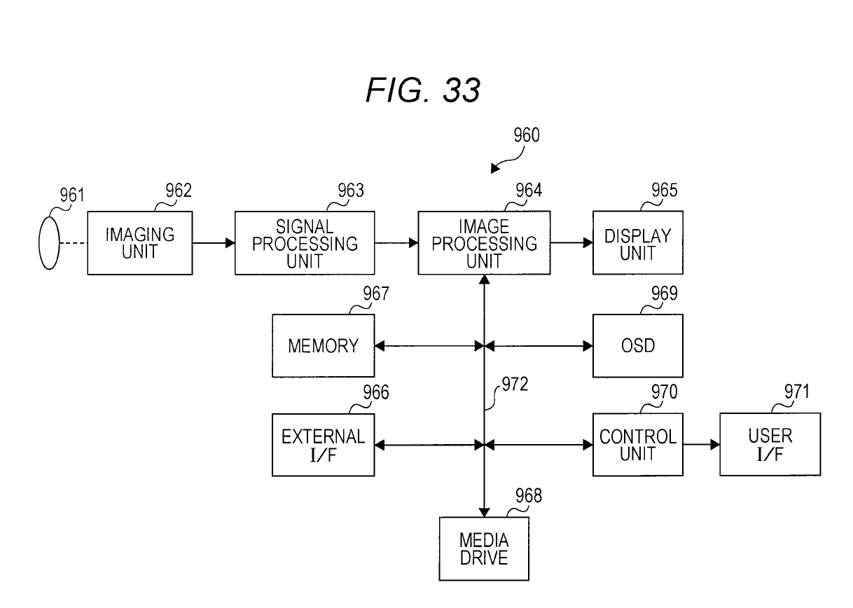

FIG. 33 schematically shows an example structure of an imaging apparatus to which the above described embodiments are applied. An imaging apparatus 960 generates images by imaging an object, encodes the image data, and records the image data on a recording medium.

The imaging apparatus 960 includes an optical block 961, an imaging unit 962, a signal processing unit 963, an image processing unit 964, a display unit 965, an external interface 966, a memory 967, a media drive 968, an OSD 969, a control unit 970, a user interface 971, and a bus 972.

The optical block 961 is connected to the imaging unit 962. The imaging unit 962 is connected to the signal processing unit 963. The display unit 965 is connected to the image processing unit 964. The user interface 971 is connected to the control unit 970. The bus 972 connects the image processing unit 964, the external interface 966, the memory 967, the media drive 968, the OSD 969, and the control unit 970 to one another.

The optical block 961 includes a focus lens and a diaphragm. The optical block 961 forms an optical image of an object on the imaging surface of the imaging unit 962. The imaging unit 962 includes an image sensor such as a CCD or a CMOS, and converts the optical image formed on the imaging surface into an image signal as an electrical signal through a photoelectric conversion. The imaging unit 962 outputs the image signal to the signal processing unit 963.

The signal processing unit 963 performs various kinds of camera signal processing such as knee correction, gamma correction, and color correction on the image signal input from the imaging unit 962. The signal processing unit 963 outputs the image data subjected to the camera signal processing to the image processing unit 964.

The image processing unit 964 encodes the image data input from the signal processing unit 963, and generates encoded data. The image processing unit 964 outputs the generated encoded data to the external interface 966 or the media drive 968. The image processing unit 964 also decodes encoded data input from the external interface 966 or the media drive 968, and generates image data. The image processing unit 964 outputs the generated image data to the display unit 965. Alternatively, the image processing unit 964 may output the image data input from the signal processing unit 963 to the display unit 965 to display images. The image processing unit 964 may also superimpose display data acquired from the OSD 969 on the images to be output to the display unit 965.

The OSD 969 generates an image of a GUI such as a menu and buttons or a cursor, for example, and outputs the generated image to the image processing unit 964.

The external interface 966 is formed as a USB input/output terminal, for example. The external interface 966 connects the imaging apparatus 960 to a printer at the time of printing of an image, for example. A drive is also connected to the external interface 966, if necessary. A removable medium such as a magnetic disk or an optical disk is mounted on the drive so that a program read from the removable medium can be installed into the imaging apparatus 960. Further, the external interface 966 may be designed as a network interface to be connected to a network such as a LAN or the Internet. That is, the external interface 966 serves as a transmission unit in the imaging apparatus 960.

A recording medium to be mounted on the media drive 968 may be a readable/rewritable removable medium such as a magnetic disk, a magnetooptical disk, an optical disk, or a semiconductor memory. Also, a recording medium may be fixed to the media drive 968, to form a non-portable storage unit such as an internal hard disk drive or an SSD (Solid State Drive).

The control unit 970 includes a processor such as a CPU, and a memory such as a RAM or a ROM. The memory stores the program to be executed by the CPU, program data, and the like. The program stored in the memory is read by the CPU at the time of activation of the imaging apparatus 960, for example, and is then executed. By executing the program, the CPU controls operations of the imaging apparatus 960 in accordance with an operating signal input from the user interface 971, for example.

The user interface 971 is connected to the control unit 970. The user interface 971 includes buttons and switches for the user to operate the imaging apparatus 960, for example. The user interface 971 generates an operating signal by detecting an operation by the user via those components, and outputs the generated operating signal to the control unit 970.

In the imaging apparatus 960 having the above described structure, the image processing unit 964 has the functions of the image encoding device 100 (FIG. 1), the functions of the image decoding device 200 (FIG. 19), the functions of the image encoding device 300 (FIG. 24), and the functions of the image decoding device 400 (FIG. 27) according to the above described embodiments. Accordingly, in an image to be encoded and decoded in the imaging apparatus 960, the image processing unit 964 can detect a region where block distortion is likely to be observed and a different predictor from that of the adjacent region is selected, and increase the deblocking filtering strength for the region. By doing so, the image processing unit 964 can reduce block distortion more accurately. Accordingly, the imaging apparatus 960 can reduce degradation of the quality of decoded images.

It is of course possible to use an image encoding device and an image decoding device according to the present technique in any apparatuses and systems other than the above described apparatuses.

In the examples described in this specification, quantization parameters are transmitted from the encoding side to the decoding side. In transmitting a quantization matrix parameter, the quantization matrix parameter may not be multiplexed with an encoded bit stream, but may be transmitted or recorded as independent data associated with an encoded bit stream. Here, the term “associate” means to link an image (or part of an image, such as a slice or a block) included in a bit stream to the information corresponding to the image at the time of decoding. In other words, the information may be transmitted through a different transmission path from images (or bit streams). Also, the information may be recorded on a different recording medium (or a different recording area in the same recording medium) from images (or bit streams). Further, each piece of the information may be associated with frames, one frame, or part of a frame of images (or bit streams).

Although preferred embodiments of the present disclosure have been described above with reference to the accompanying drawings, the technical scope of the present disclosure is not limited to those examples. It is apparent that those who have ordinary skills in the art can make various changes or modifications within the scope of the technical spirit claimed herein, and it should be understood that those changes or modifications are within the technical scope of the present disclosure.

The present technique can also be in the following forms.

(1) An image processing device including:

a determination unit that determines that block distortion is likely to be observed when a predictor used in generating a predicted image of a current image being processed differs from a predictor corresponding to an adjacent image located adjacent to the current image;

a control unit that performs control to have a higher strength set in a deblocking filtering process for the current image, when the determination unit determines that block distortion is likely to be observed; and

a filtering unit that performs, under the control of the control unit, the deblocking filtering process on the current image.

(2) The image processing device of (1), wherein, when the predictor corresponding to the current image is a Spatial Predictor while the predictor corresponding to the adjacent image is a Temporal Predictor, or when the predictor corresponding to the current image is a Temporal Predictor while the predictor corresponding to the adjacent image is a Spatial Predictor, the determination unit determines that block distortion is likely to be observed.

(3) The image processing device of (1) or (2), wherein, when bi-prediction is applied to the current image, the determination unit determines whether block distortion is likely to be observed in the current image, by using a predictor related to the List 0 predictor.

(4) The image processing device of (1) or (2), wherein, when bi-prediction is applied to the current image, the determination unit selects the List 0 predictor or the List 1 predictor depending on the distance from a reference image, and determines whether block distortion is likely to be observed, by using the selected predictor.

(5) The image processing device of any of (1) through (4), wherein the control unit controls a Bs value of the deblocking filtering process, to have a higher strength set in the deblocking filtering process for the current image determined to be likely to have block distortion to be observed.

(6) The image processing device of (5), wherein the control unit increases the Bs value by “+1”, to have a higher strength set in the deblocking filtering process for the current image determined to be likely to have block distortion to be observed.

(7) The image processing device of (5), wherein the control unit adjusts the Bs value to “4”, to have a higher strength set in the deblocking filtering process for the current image determined to be likely to have block distortion to be observed.

(8) The image processing device of any of (1) through (7), wherein the control unit controls threshold values α and β of the deblocking filtering process, to have a higher strength set in the deblocking filtering process for the current image determined to be likely to have block distortion to be observed.

(9) The image processing device of (8), wherein the control unit corrects the quantization parameter to be used in calculating the threshold values α and β, to have a higher strength set in the deblocking filtering process for the current image determined to be likely to have block distortion to be observed.

(10) An image processing method implemented in an image processing device,

the image processing method including:

determining that block distortion is likely to be observed when a predictor used in generating a predicted image of a current image being processed differs from a predictor corresponding to an adjacent image located adjacent to the current image, the determining being performed by a determination unit;

performing control to have a higher strength set in a deblocking filtering process for the current image when the determination unit determines that block distortion is likely to be observed, the control being performed by a control unit; and,

under the control of the control unit, performing the deblocking filtering process on the current image, the deblocking filtering process being performed by a filtering unit.

### REFERENCE SIGNS LIST

100 Image encoding device, 111 Deblocking filter, 121 Motion vector encoding unit, 122 Region determination unit, 123 Boundary control unit, 151 Spatial adjacent motion vector buffer, 152 Temporal adjacent motion vector buffer, 153 Candidate predicted motion vector generation unit, 154 Cost function calculation unit, 155 Optimum predictor determination unit, 161 Adjacent predictor buffer, 162 Region determination unit, 171 Bs determination unit, 172 α/β determination unit, 173 Filter determination unit, 174 Filtering unit, 200 Image decoding device, 206 Deblocking filter, 221 Motion vector decoding unit, 222 Region determination unit, 223 Boundary control unit, 251 Optimum predictor buffer, 252 Difference motion vector information buffer, 253 Predicted motion vector reconstruction unit, 254 Motion vector reconstruction unit, 255 Spatial adjacent motion vector buffer, 256 Temporal adjacent motion vector buffer, 261 Adjacent predictor buffer, 262 Region discrimination unit, 271 Bs determination unit, 272 an determination unit, 273 Filter determination unit, 274 Filtering unit, 300 Image encoding device, 311 Deblocking filter, 323 Boundary control unit, 371 Bs determination unit, 372 α/β determination unit, 400 Image decoding device, 406 Deblocking filter, 423 Boundary control unit, 471 Bs determination unit, 472 α/β determination unit

1. An image processing device comprising:
a determination unit configured to determine that block distortion is likely to be observed when a predictor used in generating a predicted image of a current image being processed differs from a predictor corresponding to an adjacent image located adjacent to the current image;
a control unit configured to perform control to have a higher strength set in a deblocking filtering process for the current image, when the determination unit determines that block distortion is likely to be observed; and
a filtering unit configured to perform, under the control of the control unit, the deblocking filtering process on the current image.

2. The image processing device according to claim 1, wherein, when the predictor corresponding to the current image is a Spatial Predictor while the predictor corresponding to the adjacent image is a Temporal Predictor, or when the predictor corresponding to the current image is a Temporal Predictor while the predictor corresponding to the adjacent image is a Spatial Predictor, the determination unit determines that block distortion is likely to be observed.

3. The image processing device according to claim 1, wherein, when bi-prediction is applied to the current image, the determination unit determines whether block distortion is likely to be observed in the current image, by using a predictor related to the List 0 predictor.

4. The image processing device according to claim 1, wherein, when bi-prediction is applied to the current image, the determination unit selects one of the List 0 predictor and the List 1 predictor depending on a distance from a reference image, and determines whether block distortion is likely to be observed, by using the selected one of the predictors.

5. The image processing device according to claim 1, wherein the control unit controls a Bs value of the deblocking filtering process, to have a higher strength set in the deblocking filtering process for the current image determined to be likely to have block distortion to be observed.

6. The image processing device according to claim 5, wherein the control unit increases the Bs value by “+1”, to have a higher strength set in the deblocking filtering process for the current image determined to be likely to have block distortion to be observed.

7. The image processing device according to claim 5, wherein the control unit adjusts the Bs value to “4”, to have a higher strength set in the deblocking filtering process for the current image determined to be likely to have block distortion to be observed.

8. The image processing device according to claim 1, wherein the control unit controls threshold values α and β of the deblocking filtering process, to have a higher strength set in the deblocking filtering process for the current image determined to be likely to have block distortion to be observed.

9. The image processing device according to claim 8, wherein the control unit corrects a quantization parameter to be used in calculating the threshold values α and β, to have a higher strength set in the deblocking filtering process for the current image determined to be likely to have block distortion to be observed.

10. An image processing method implemented in an image processing device,
the image processing method comprising:
determining that block distortion is likely to be observed when a predictor used in generating a predicted image of a current image being processed differs from a predictor corresponding to an adjacent image located adjacent to the current image, the determining being performed by a determination unit;
performing control to have a higher strength set in a deblocking filtering process for the current image when the determination unit determines that block distortion is likely to be observed, the control being performed by a control unit; and,
under the control of the control unit, performing the deblocking filtering process on the current image, the deblocking filtering process being performed by a filtering unit.
